(19) United States
(12) Patent Application Publication
(10) Pub. No.: US 2026/0095640 A1
(43) Pub. Date: Apr. 2, 2026

(54) INSERTION GUIDE DEVICE FOR ENDOSCOPE AND ENDOSCOPE SYSTEM

(71) Applicant: Evident Inspection Technologies Japan Corporation, Nagano (JP)

(72) Inventor: Yasuo HIRATA, Kamiina-gun (JP)

(73) Assignee: Evident Inspection Technologies Japan Corporation, Nagano (JP)

(21) Appl. No.: 19/344,814

(22) Filed: Sep. 30, 2025

(30) Foreign Application Priority Data
Oct. 1, 2024 (JP) 2024-172657

(51) Int. Cl. H04N 23/50

(52) U.S. Cl. CPC H04N 23/555

(57) ABSTRACT

An insertion guide device used in an endoscope including an insertion portion extending in a longitudinal direction and having a distal end and a proximal end and guides insertion of the insertion portion into a subject, includes: a flat plate-shaped member that extends in the longitudinal direction and has a width perpendicular to the longitudinal direction and a thickness perpendicular to the longitudinal direction and the width, the thickness being smaller than the width; and a holding member that attaches and holds a distal end portion of the insertion portion to a width direction side surface on a distal end side of the flat plate-shaped member, wherein the flat plate-shaped member has a bent portion that is bent in a direction of the thickness at a distal end, and wherein the holding member is arranged on a proximal end side with respect to the bent portion.

### BACKGROUND OF THE INVENTION

### Field of the Invention

The present invention relates to an insertion guide device for an endoscope which is used when inserting an endoscope insertion portion into a narrow space inside a subject such as a structure and guides insertion of the insertion portion, and an endoscope system that includes the insertion guide device for an endoscope. Priority is claimed on Japanese Patent Application No. 2024-172657, filed October 1, 2024, the content of which is incorporated herein by reference.

### Description of Related Art

In the related art, endoscope systems have been widely used in, for example, medical fields, industrial fields, and the like. Among these, an industrial endoscope system used in the industrial field is used to observe and inspect the internal condition of each of structures such as industrial plants or various engines (hereinafter referred to as subjects) by inserting an insertion portion equipped with an imaging unit at a distal end into an internal space of each of the subjects.

In the industrial endoscope system, many of the subjects to be observed and inspected have complex internal structures and are formed with many narrow spaces inside. It is well known that it is difficult to insert a flexible insertion portion into such a narrow space having a complex internal structure.

Therefore, in this type of endoscope system, there is a constant demand for technical innovations that will enable smooth and easy insertion of the endoscope regardless of the internal structure of the subject.

For example, regarding an insertion guide device for an endoscope which is used when inserting an endoscope insertion portion into a narrow space inside a subject and guides insertion of the insertion portion, various proposals have been made in Japanese Unexamined Patent Application, First Publication No. 2018-189897, Japanese Unexamined Patent Application, First Publication No. 2012-14130, and the like.

The insertion guide devices for an endoscope which are disclosed in Japanese Unexamined Patent Application, First Publication No. 2018-189897, Japanese Unexamined Patent Application, First Publication No. 2012-14130, and the like include a flexible tubular member through which an insertion portion of an endoscope is inserted and a band-shaped flat plate guide member having elasticity, wherein the tubular member is disposed on a flat surface of the band-shaped flat plate member, and a distal end of the tubular member is positioned and fixed to a distal end region on the flat surface of the band-shaped flat plate member.

With this configuration, the insertion guide devices for an endoscope of the related art which are described in the above publications can smoothly insert and remove the endoscope insertion portion into and from the internal space of a linear, spiral, or helical pipe and can also guide a distal end portion of the endoscope insertion portion to a desired position inside the subject.

### SUMMARY OF THE INVENTION

According to one aspect of the present invention, there is provided an insertion guide device for an endoscope which is used in an endoscope including an insertion portion extending in a longitudinal direction and having a distal end and a proximal end and guides insertion of the insertion portion into a subject, the insertion guide device including: a flat plate-shaped member that extends in the longitudinal direction and has a width perpendicular to the longitudinal direction and a thickness perpendicular to the longitudinal direction and the width, the thickness being smaller than the width; and a holding member that attaches and holds a distal end portion of the insertion portion to a width direction side surface on a distal end side of the flat plate-shaped member, wherein the flat plate-shaped member has a bent portion that is bent in a direction of the thickness at a distal end, and wherein the holding member is arranged on a proximal end side with respect to the bent portion.

According to another aspect of the present invention, there is provided an endoscope system including: an endoscope including an insertion portion that extends in a longitudinal direction, has a distal end and a proximal end, and has a thin and tubular shape, an operation portion to which the proximal end of the insertion portion is connected and which is equipped with various operation members, and a cable extending from the operation portion; and an insertion guide device for an endoscope which guides insertion of the insertion portion, wherein the insertion guide device for an endoscope includes: a flat plate-shaped member that extends in the longitudinal direction of the insertion portion and has a width perpendicular to the longitudinal direction and a thickness perpendicular to the longitudinal direction and the width, the thickness being smaller than the width; and a holding member that attaches and holds a distal end portion of the insertion portion to a width direction side surface of the flat plate-shaped member, wherein the flat plate-shaped member has a bent portion that is bent in a thickness direction at a distal end, and wherein the holding member is arranged on a proximal end side with respect to the bent portion.

### BRIEF DESCRIPTION OF THE DRAWINGS

FIG. 1 is a schematic configuration view showing a configuration example of an endoscope system according to one embodiment of the present invention.

FIG. 2 is a main part enlarged perspective view showing a part of a distal end region of an insertion guide device for an endoscope according to the one embodiment of the present invention.

FIG. 3 is a plan view of the insertion guide device for an endoscope of FIG. 2 as seen from a position in front thereof (in a direction indicated by an arrow [3] in FIG. 2).

FIG. 4 is a schematic view showing an example of a structure of a subject to be observed and inspected using an endoscope system including the insertion guide device according to the one embodiment of the present invention and showing a side cross section of an internal structure of the subject.

FIG. 5 is a view seen in a direction of an arrow [5] in FIG. 4 (a view of an insertion opening as seen from a position in front thereof) and also schematically shows an extent of an internal space of the subject.

FIG. 6 is an operational view showing a state in which a distal end of the insertion guide device according to the one embodiment of the present invention is in contact with a vertical wall surface after the insertion guide device is inserted into the internal space of the subject.

FIG. 7 is an operational view showing a state in which an advancing direction of the distal end of the insertion guide device is changed upward after the state of FIG. 6.

FIG. 8 is a main part enlarged perspective view showing a part of a distal end region of an insertion guide device according to a first modification example of the one embodiment of the present invention.

FIG. 9 is a plan view of the insertion guide device of FIG. 8 as seen from a position in front thereof (in a direction indicated by an arrow [9] in FIG. 8).

FIG. 10 is an operational view of the insertion guide device of FIG. 8.

FIG. 11 is a main part enlarged perspective view showing a part of a distal end region of an insertion guide device according to a second modification example of the one embodiment of the present invention.

FIG. 12 is a plan view of the insertion guide device of FIG. 11 as seen from a position in front thereof (in a direction indicated by an arrow [12] in FIG. 11).

FIG. 13 is a plan view of the insertion guide device of FIG. 11 as seen from a side thereof (in a direction indicated by an arrow [13] in FIG. 11).

FIG. 14 is an operational view of the insertion guide device of FIG. 11.

FIG. 15 is a main part enlarged perspective view showing a part of a distal end region of an insertion guide device according to a third modification example of the one embodiment of the present invention.

FIG. 16 is a plan view of the insertion guide device of FIG. 15 as seen from a position in front thereof (in a direction indicated by an arrow [16] in FIG. 15).

FIG. 17 is a main part enlarged perspective view showing a part of a distal end region of an insertion guide device according to a fourth modification example of the one embodiment of the present invention.

FIG. 18 is a main part enlarged perspective view showing a part of a distal end region of an insertion guide device according to a fifth modification example of the one embodiment of the present invention.

FIG. 19 is a main part enlarged perspective view showing a part of a distal end region of an insertion guide device according to a sixth modification example of the one embodiment of the present invention.

FIG. 20 is a main part enlarged perspective view showing a part of a distal end region of an insertion guide device according to a seventh modification example of the one embodiment of the present invention.

FIG. 21 is a main part enlarged perspective view showing a part of a distal end region of an insertion guide device according to an eighth modification example of the one embodiment of the present invention.

FIG. 22 is a main part enlarged perspective view showing a part of a distal end region of an insertion guide device according to a ninth modification example of the one embodiment of the present invention.

FIG. 23 is a main part enlarged perspective view showing a part of a distal end region of an insertion guide device according to a tenth modification example of the one embodiment of the present invention.

FIG. 24 is a main part enlarged perspective view showing a part of a distal end region of an insertion guide device according to an eleventh modification example of the one embodiment of the present invention.

FIG. 25 is a main part enlarged perspective view showing a part of a distal end region of an insertion guide device according to a twelfth modification example of the one embodiment of the present invention.

FIG. 26 is a main part enlarged perspective view showing a part of a distal end region of an insertion guide device according to a thirteenth modification example of the one embodiment of the present invention.

FIG. 27 is a main part enlarged perspective view showing a part of a distal end region of an insertion guide device according to a fourteenth modification example of the one embodiment of the present invention.

FIG. 28 is a main part enlarged perspective view showing a part of a distal end region of an insertion guide device according to a fifteenth modification example of the one embodiment of the present invention.

FIG. 29 is a perspective view showing a schematic configuration of an insertion guide device according to a sixteenth modification example of the one embodiment of the present invention.

FIG. 30 is an operational view showing a state in the middle of a folding process of the insertion guide device of FIG. 29.

FIG. 31 is an operational view showing a state in which the folding of the insertion guide device of FIG. 29 is completed.

FIG. 32 is a main part enlarged perspective view showing a part of a distal end region of an insertion guide device according to a seventeenth modification example of the one embodiment of the present invention.

FIG. 33 is a main part enlarged perspective view showing a part of a distal end region of an insertion guide device according to an eighteenth modification example of the one embodiment of the present invention.

FIG. 34 is an operational view of the insertion guide device of FIG. 33 when it is stored.

FIG. 35 is a main part enlarged perspective view showing a part of a distal end region of an insertion guide device according to a nineteenth modification example of the one embodiment of the present invention.

FIG. 36 is a main part enlarged perspective view showing a part of a distal end region of an insertion guide device according to a twentieth modification example of the one embodiment of the present invention.

FIG. 37 is a main part enlarged perspective view showing a part of a distal end region of an insertion guide device according to a twenty-first modification example of the one embodiment of the present invention.

FIG. 38 is a main part enlarged perspective view showing a part of a distal end region of an insertion guide device according to a twenty-second modification example of the one embodiment of the present invention.

FIG. 39 is a main part enlarged perspective view showing a part of a distal end region of an insertion guide device according to a twenty-third modification example of the one embodiment of the present invention.

FIG. 40 is a main part enlarged perspective view showing a part of a distal end region of an insertion guide device according to a twenty-fourth modification example of the one embodiment of the present invention.

FIG. 41 is a main part enlarged perspective view showing a part of a distal end region of an insertion guide device according to a twenty-fifth modification example of the one embodiment of the present invention.

### DETAILED DESCRIPTION OF THE INVENTION

The present invention will be described below with reference to illustrated embodiments. The drawings used in the following description are schematic illustrations. Therefore, in each of these drawings, each component is shown at a size that allows it to be recognized on the drawing. For this reason, the dimensional relationships and scales of members in the drawings may be shown differently for each component. The present invention is not limited to only the illustrated embodiments in terms of the number, shapes, size ratios, relative positional relationships, and the like of the components shown in the drawings.

### One embodiment

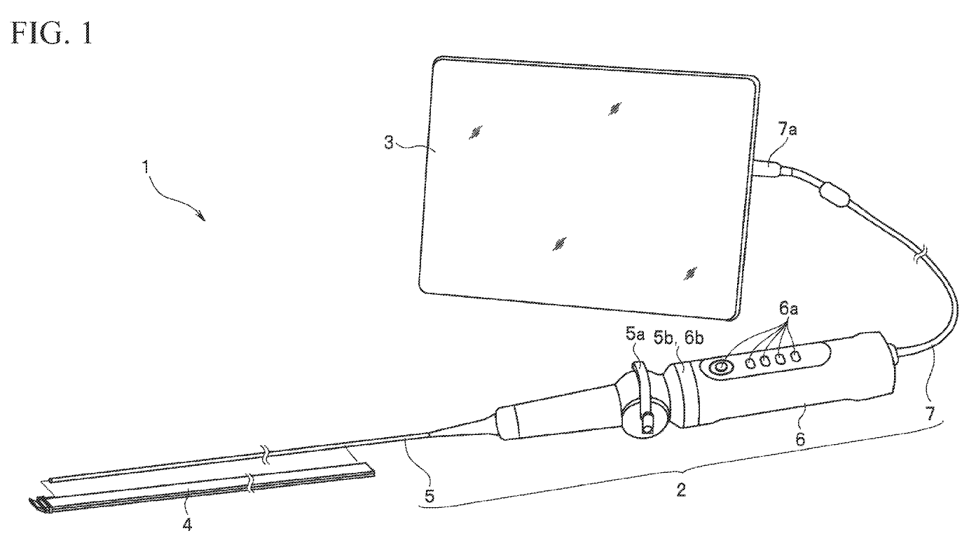

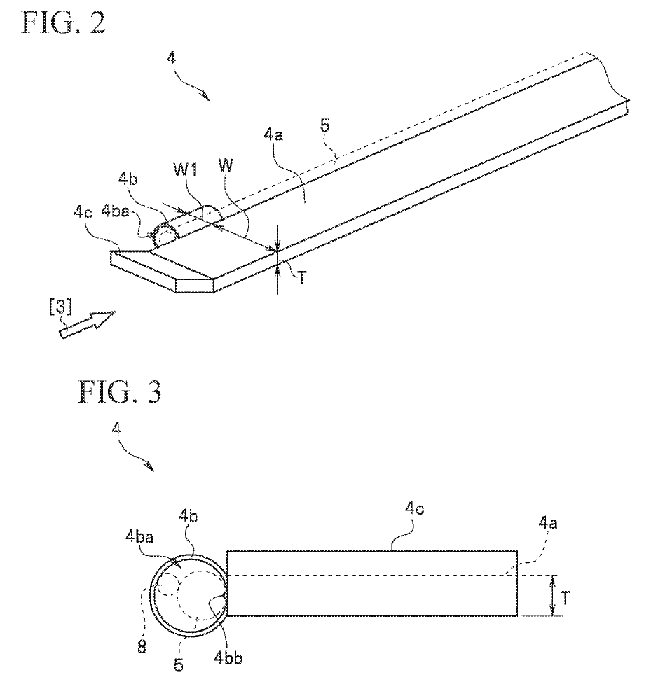

First, a schematic configuration of an endoscope system including an insertion guide device for an endoscope according to one embodiment of the present invention will be briefly described below. FIG. 1 is a schematic configuration view showing a configuration example of the endoscope system according to the one embodiment of the present invention. FIG. 2 is a main part enlarged perspective view showing a part of a distal end region of the insertion guide device for an endoscope according to the one embodiment of the present invention. FIG. 3 is a plan view of the insertion guide device for an endoscope of FIG. 2 as seen from a position in front thereof (in a direction indicated by an arrow [3] in FIG. 2).

As shown in FIG. 1, an endoscope system 1 has an endoscope 2, a main body device 3, an insertion guide device for an endoscope (hereinafter referred to as an insertion guide device) 4, and the like.

The endoscope 2 includes an insertion portion 5, an operation portion 6, and a universal cable 7. The insertion portion 5 extends in a longitudinal direction, has a distal end and a proximal end, and is formed in an elongated, flexible tubular shape as a whole.

Here, in the longitudinal direction of the extension of the insertion portion 5 of the endoscope 2, an end portion on a side on which a distal end portion is disposed is referred to as a distal end. An end portion on a side opposite to the distal end side, that is, an end portion on a side on which the operation portion 6 is disposed, is referred to as a proximal end.

In addition, the insertion portion 5 has a bending operation lever 5a and a connector 5b at a portion on the proximal end side. The bending operation lever 5a is an operation member that performs a bending operation on a bending portion (not shown) that forms a partial region of the insertion portion 5. The bending operation lever 5a pulls or loosens a plurality of bending operation wires (not shown) that are inserted and disposed inside the insertion portion 5 to be freely advanced and retreated in the longitudinal direction, depending on the operation, thereby realizing the bending operation of the bending portion.

The connector 5b is a connecting member that connects the insertion portion 5 and the operation portion 6 to each other. The connector 5b is connected to a connector 6b provided on a distal end side of the operation portion 6, thereby connecting the insertion portion 5 and the operation portion 6 to each other.

The operation portion 6 is a configuration unit having a plurality of operation members 6a and the connector 6b. The plurality of operation members 6a are used to perform various operations of the endoscope 2, for example, a zoom operation to enlarge or reduce a display of an observation image (hereinafter simply referred to as a display image) displayed on a display screen, an operation to adjust a brightness of the display image, an operation to request a menu display, an operation to switch a display format of the display image, an operation to record or play back a moving image or a still image, and the like. As the plurality of operation members 6a, it is possible to employ various forms, for example, a push button, a slide switch, a rotary dial, and the like.

As described above, the connector 6b is a connecting member that is connected to the connector 5b of the insertion portion 5 to connect the operation portion 6 and the insertion portion 5 to each other.

The universal cable 7 is a long, thin cable extending from the proximal end of the operation portion 6. The universal cable 7 has various signal cables, a light guide bundle, and the like inserted therethrough and is provided with a connector 7a at a distal end thereof. This connector 7a is connected to a connector portion (not shown) of the main body device 3. As a result, the universal cable 7 electrically connects the operation portion 6 and the main body device 3 to each other.

The main body device 3 incorporates a central processing unit (CPU), ROM, RAM, a control unit, an image processing unit, a light source, a large-capacity storage device, a display device, and the like. The connector 7a of the universal cable 7 is connected to the main body device 3.

A display device included in the main body device 3 displays images based on image data acquired by an imaging element (not shown) provided at the distal end portion of the insertion portion 5 of the endoscope 2, and the like, as well as various items of information generated in the control unit, and the like.

The light source may be disposed inside the operation portion 6 in addition to being disposed in the main body device 3. In the case of this configuration, the light guide bundle inside the universal cable 7 can be omitted.

The endoscope 2 and the main body device 3 formed as described above basically have substantially the same configuration as the known endoscope of the related art, and therefore explanation and illustration of the configuration other than that described above will be omitted.

Next, the configuration of the insertion guide device 4 according to the one embodiment of the present invention will be described below.

As shown in FIGS. 2 and 3, the insertion guide device 4 of the present embodiment includes a flat plate-shaped member 4a made of a plastic with good slipperiness, such as acrylic, peek, or Teflon (registered trademark), or a metal plate such as stainless steel, and a cylindrical member 4b.

The flat plate-shaped member 4a extends in the longitudinal direction and is formed of a band-shaped flat plate. A cross section of the flat plate-shaped member 4a which is perpendicular to the longitudinal direction is rectangular (a quadrilateral with all corners being right angles) having a width W perpendicular to the longitudinal direction and a thickness T perpendicular to the longitudinal direction and also perpendicular to the width W.

Here, in the cross section of the flat plate-shaped member 4a, the thickness T is smaller than the width W (W > T). Therefore, with this configuration, the flat plate-shaped member 4a has flexibility in a direction of the thickness T and has no flexibility or little flexibility in a direction of the width W.

Furthermore, the flat plate-shaped member 4a has a bent portion 4c that is bent in one direction in the direction of the thickness T and protrudes obliquely forward from a distal end thereof.

The cylindrical member 4b is a holding member that attaches and holds the distal end portion of the insertion portion 5 to a side portion of the flat plate-shaped member 4a in the direction of the width W. The cylindrical member 4b is provided with a through hole 4ba through which the insertion portion 5 is inserted and a stationary portion 4bb that fixes the distal end portion of the insertion portion 5 in a state in which it is inserted into the through hole 4ba and is formed in a short cylindrical shape as a whole. The cylindrical member 4b is disposed on a proximal end side with respect to the bent portion 4c and on the side portion of the flat plate-shaped member 4a near the distal end thereof.

As shown in FIG. 2, the cylindrical member 4b has a width W1. Therefore, the width dimension of the insertion guide device 4 itself is W+W1. Therefore, the subject to be observed and inspected using the insertion guide device 4 is a subject having an insertion opening with a width dimension greater than at least the width W+W1.

Although detailed illustration is omitted for the stationary portion 4bb, it is sufficient that a known fixing means using, for example, a click stop mechanism or a snap fit mechanism is used. For this reason, the cylindrical member 4b is made of, for example, an elastic resin member.

In this case, a fixing force amount is not required to be a strong fixing force, but it is sufficient that a slightly weak fixing force is ensured. For example, when the insertion guide device 4 to which the insertion portion 5 of the endoscope 2 is attached is inserted into the subject, it is sufficient that there is a fixing force amount for keeping a state in which the insertion portion 5 is fixed to the cylindrical member 4b.

This is due to the following reasons. That is, the insertion portion 5 of the endoscope 2 is guided to a desired observation portion inside the subject using the insertion guide device 4 and then further advanced forward of the bent portion 4c for observation and inspection. At this time, the insertion portion 5 needs to be freely advanced and retreated in a state in which the insertion portion 5 is inserted into the through hole 4ba. Therefore, the fixing force amount of the insertion portion 5 by the stationary portion 4bb is set to a level that allows the fixed state of the insertion portion 5 by the stationary portion 4bb to be released as needed by advancing and retreating the insertion portion 5 even when the insertion portion 5 is inside the subject.

Furthermore, the cylindrical member 4b may be formed to have a function of inserting and locking, for example, one of treatment tools and the like 8, in addition to the insertion portion 5 (see FIG. 3).

In the above description, the cylindrical member 4b is provided at a part of the distal end of the flat plate-shaped member 4a, but the cylindrical member 4b may be a flexible tube member extending to the proximal end side of the flat plate-shaped member 4a. The tube member is made of urethane, Teflon (registered trademark), nylon, Hytrel, or the like, and it is possible to insert the endoscope 2 into the tube member, to push the endoscope 2 out from a proximal end side of the tube member, and then to push the endoscope out from a distal end of the tube member, allowing the endoscope 2 to be sent deep into the subject.

Next, an operation of the endoscope system 1 including the insertion guide device 4 formed as described above when observing and inspecting an internal space of the subject will be described below.

Here, a structure of the subject in a case in which the insertion guide device 4 of the present embodiment is used is assumed to be, for example, a structure in which an insertion opening leading to the internal space of the subject has a cross-sectional area that allows the insertion guide device 4 to be inserted therethrough and the internal space forward from the insertion opening is wide in the width direction but is narrow in the thickness direction.

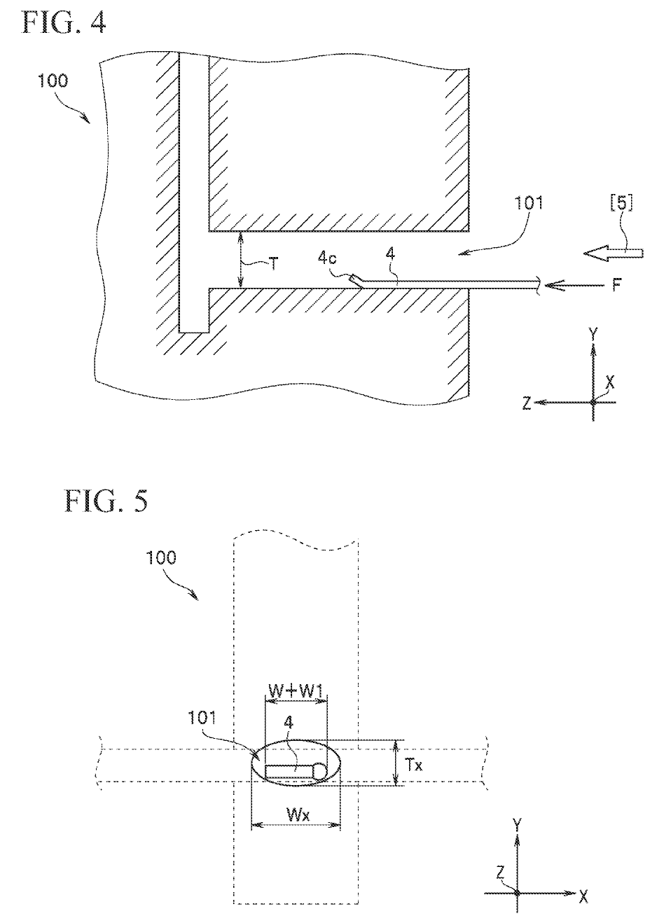

Specifically, for example, the subject structure as shown in FIGS. 4 and 5 is assumed. FIGS. 4 and 5 are schematic views showing an example of a structure of a subject to be observed and inspected using an endoscope system including the insertion guide device according to the present embodiment. Of these, FIG. 4 is a schematic view showing a side cross section of an internal structure of the subject. FIG. 5 is a view seen in a direction of an arrow [5] in FIG. 4 (a view of an insertion opening as seen from a position in front thereof) and also schematically shows an extent of an internal space of the subject.

In a subject 100 shown in FIGS. 4 and 5, an insertion opening 101 is assumed to be elliptical or rectangular with a width Wx and a thickness Tx (the illustrated example is elliptical). Here, since a width dimension Wa of the insertion guide device 4 is the sum of the width W of the flat plate-shaped member 4a and the width W1 of the cylindrical member 4b, the width Wx of the insertion opening 101 is greater than the width W+W1 of the flat plate-shaped member 4a itself (Wx > W+W1).

In addition, the internal space forward from the insertion opening 101 has a structure that is wide in the width direction but is narrow in the thickness direction. Furthermore, the subject 100 shown in FIGS. 4 and 5 has a structure in which the space is advanced forward (in a Z-axis direction) from the insertion opening 101 and then extends in a vertical direction (in a Y-axis direction).

In the case of the subject 100 having such a structure, it is difficult to advance the endoscope 2 alone in the vertical direction (the Y-axis direction), especially in the upward direction (a Y1 direction). For example, in a case in which the endoscope is inserted into the inside of the subject while the direction of the endoscope is changed into the Y1 direction from a point at which the distal end portion comes into contact with a wall surface and then the endoscope is stood up, in a pipe that is wide in the width direction or has a large diameter, even when the endoscope tries to advance upward, the endoscope 2 will be inclined to left and right lateral directions relative to an advancing direction (upward) due to its own weight and will be advanced obliquely, making it impossible to stand the endoscope up straight.

Even though the subject 100 has such an internal structure, observation and inspection can be easily performed by using the insertion guide device 4 of the present embodiment. Specific examples of the subject having this type of structure include a building wall having a gap therein and a large-diameter pole of an outdoor street lamp or the like.

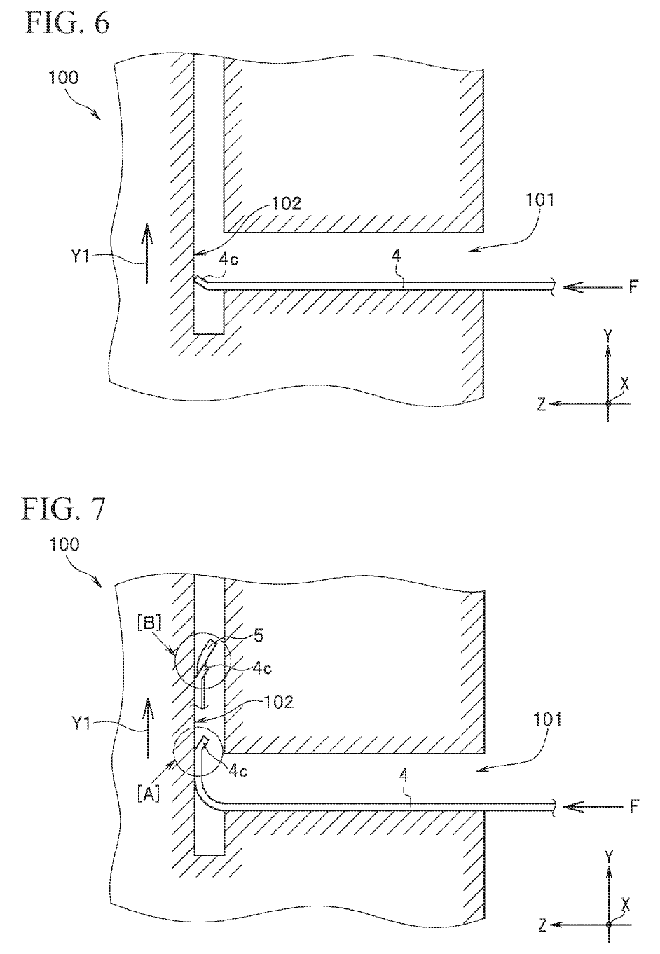

The operation of the endoscope system 1 including the insertion guide device 4 of the present embodiment when observing and inspecting the internal space of the subject is schematically as follows. FIGS. 6 and 7 are schematic views showing the operation of the endoscope system including the insertion guide device according to the present embodiment. Of these, FIG. 6 shows a state in which a distal end of the insertion guide device is in contact with a vertical wall surface after the insertion guide device is inserted into the internal space of the subject. FIG. 7 shows a state in which an advancing direction of the distal end of the insertion guide device is changed upward after the state of FIG. 6.

First, the distal end portion of the insertion portion 5 is inserted into the through hole 4ba of the cylindrical member 4b of the insertion guide device 4, and the distal end portion of the insertion portion 5 is fixed by the stationary portion 4bb. As a result, the insertion guide device 4 is in the state shown in FIGS. 2 and 3.

The distal end portion of the insertion guide device 4 is inserted into the internal space from the insertion opening 101 of the subject 100, and the insertion guide device 4 is pushed in a direction indicated by the arrow F in FIG. 4. The state at this time is shown in FIG. 4.

Then, the distal end of the insertion guide device 4 (the distal end of the bent portion 4c) eventually comes into contact with a vertical wall surface 102 of the internal space of the subject 100, as shown in FIG. 6. From this state, the insertion guide device 4 is further advanced in the direction of the arrow F. Then, as shown in FIG. 7, the distal end of the insertion guide device 4 changes a course upward (in the direction of the arrow Y1) along the vertical wall surface 102 (see a position of a reference sign [A] in FIG. 7). At this time, the advancing direction of the distal end of the insertion guide device 4 corresponds to the bending direction of the bent portion 4c. Therefore, if the desired portion to be observed in the internal space is known in advance, it is desirable to set the bending direction of the bent portion 4c when inserting the insertion guide device 4 into the subject.

Here, when the insertion guide device 4 is further advanced in the direction of the arrow F, the insertion guide device 4 is flexible in the thickness direction and has elasticity, and thus it is pressed against the wall surface, but the insertion guide device 4 has no (or little) flexibility in the width direction, and thus it does not fall over in the width direction, and therefore the distal end of the insertion guide device 4 advances along the vertical wall surface 102 (see a position of a reference sign [B] in FIG. 7).

In this way, the insertion guide device 4 guides the distal end portion of the insertion portion 5 to a desired portion inside the subject. Then, when the insertion portion 5 reaches the desired portion, the insertion portion 5 of the endoscope 2 is pushed out in the insertion direction while the insertion guide device 4 maintains its position inside the subject. As a result, the distal end of the insertion portion 5 can be advanced forward from the bent portion 4c at the distal end of the insertion guide device 4, as shown in FIG. 7 (see a reference sign [B] in FIG. 7). In a case in which the endoscope 2 is used by extending it from the distal end of the cylindrical member 4b, since the cylindrical member 4b is located on the proximal end side, the flat plate-shaped member 4a collides against the subject and changes a direction. At this time, the endoscope 2 escapes and is less likely to be subjected to a force when colliding against the subject directly, making it less likely to break down. In a case in which the endoscope 2 is used by aligning it with a distal end position of the cylindrical member 4b, since the cylindrical member 4b is located on the proximal end side, the flat plate-shaped member 4a collides against the subject first, and the distal end of the endoscope 2 does not come into direct contact with the subject, and thus the endoscope 2 is less likely to be subjected to a force and is less likely to break down.

In this state, for example, by operating a bending operation lever of the operation portion 6 to bend the bending portion of the insertion portion 5, the observation and inspection direction can be changed, allowing observation and inspection of the desired portion, such as the wall surface condition, to be performed. In addition, by pressing an operating member corresponding to the desired function among the plurality of operation members 6a of the operation portion 6, an image of the portion to be observed and inspected can be displayed in a predetermined form (a form such as a still image or a moving image) on the display screen of the display device of the main body device 3, or image data can be recorded or played back.

In a case in which a tube member extending from the distal end to the proximal end is used instead of the cylindrical member 4b, the endoscope 2 can be pushed further out from the tube member, making it possible to insert the endoscope into an even narrower portion (not shown) that is deep.

In this way, after the desired observation and inspection has been performed, in a case in which the observation and inspection has ended, the insertion portion 5 is first removed, and thus the distal end portion of the insertion portion 5 is fixed to the cylindrical member 4b. In this state, the insertion guide device 4 is moved in a removal direction (a direction opposite to the arrow F). During this process, the insertion guide device 4 moves smoothly along the wall surface in the internal space of the subject. Therefore, the insertion guide device 4 can be removed smoothly and easily.

The form of the endoscope system 1 shown in FIG. 1 is merely an example.

Therefore, the internal structure of the subject suitable for observation and inspection using the insertion guide device 4 of the present embodiment is not limited to the structure shown in the example described above. For example, it is effective for the following subjects. Specifically, for example, a structure in which the internal space forward from the insertion opening is formed obliquely in the left and right width direction (the X-axis direction), a complex structure in which an insertion passage in the internal space changes a plurality of times or repeatedly in the vertical direction (the Y-axis direction) or the left and right width direction (the X-axis direction), and the like can be considered. Examples of a configuration of the subject having this kind of the complex structure include various internal combustion engines and the like.

As described above, according to the one embodiment described above, the insertion guide device 4 is used in the endoscope 2 including the insertion portion 5 extending in the longitudinal direction and having the distal end and the proximal end and guides the insertion of the insertion portion 5 into the subject 100.

This insertion guide device 4 includes the flat plate-shaped member 4a extending in the longitudinal direction and having the width W perpendicular to the longitudinal direction and the thickness T perpendicular to the longitudinal direction and perpendicular to the width W, with the thickness T being smaller than the width W, and the cylindrical member 4b that attaches the distal end portion of the insertion portion 5 to the lateral side of the flat plate-shaped member 4a in the direction of the width W. Here, the flat plate-shaped member 4a has a bent portion 4c that is bent in the direction of the thickness T at the distal end thereof. In addition, the cylindrical member 4b has the cylindrical shape, is provided with the through hole 4ba through which the insertion portion 5 is inserted and the stationary portion 4bb that fixes the distal end portion of the insertion portion 5 in a state in which the insertion portion 5 is inserted into the through hole 4ba, and is disposed on the proximal end side with respect to the bent portion 4c.

The insertion guide device 4 having such a configuration is suitable for observing and inspecting the subject 100 in which the internal space forward from the insertion opening 101 has a structure that is wide in the direction of the width W but is narrow in the direction of the thickness T and furthermore, has a structure having a space that extends in the vertical direction (the Y-axis direction) after advancing forward from the insertion opening 101 (the Z-axis direction).

That is, when observing and inspecting the inside of a subject having such an internal space, first, the insertion guide device 4 is inserted through the insertion opening 101, and then, even if the internal space is wide in the width direction, the insertion portion 5 attached to the flat plate-shaped member 4a can be advanced in a straight line without being swayed in the left and right width direction.

Furthermore, when the structure is such that after the insertion guide device 4 has been advanced in a straight line through the internal space forward from the insertion opening 101, the vertical wall surface 102 is present and a space extending in the vertical direction (the Y-axis direction) of the vertical wall surface 102 is present, the advancing direction of the insertion guide device 4 can be smoothly changed by simply applying a further pushing force amount in a straight direction after the distal end of the insertion guide device 4 comes into contact with the vertical wall surface 102.

This is because the bent portion 4c is provided at the distal end of the flat plate-shaped member 4a, and the distal end of the bent portion 4c can move smoothly along the internal wall surface even at a bent portion of the internal space. Therefore, by providing the bent portion 4c, it is possible to contribute to improving the ease of insertion in the bent portion of the internal space.

The flat plate-shaped member 4a is formed such that the thickness T is smaller than the width W (W > T), and at the same time, the distal end of the insertion portion 5 is attached to the cylindrical member 4b provided on the lateral surface of the flat plate-shaped member 4a, and thus it is possible to make the structure that allows the flat plate-shaped member 4a to be easily bent in the direction of the thickness T.

Therefore, by using the insertion guide device 4 of the present embodiment, the insertion and removal of the insertion portion 5 can always be performed smoothly and easily. At the same time, according to the insertion guide device 4, it is possible to easily and reliably guide the distal end portion of the insertion portion 5 to a desired portion inside the subject. Therefore, reliable observation and inspection can always be performed. Even when the insertion portion 5 is removed, a smooth operation can be ensured.

In the insertion guide device 4 of the one embodiment described above, an example in which the insertion guide device 4 is formed using one flat plate-shaped member 4a has been illustrated, but the present invention is not limited to such a configuration example. A configuration example of the insertion guide device according to the one embodiment of the present invention can be formed as various modification examples which will be described below.

Each of the modification examples which will be described below basically has substantially the same configuration as the one embodiment described above, or the modification examples have configurations substantially similar to each other. Therefore, in the following description of each of the modification examples, the same components as those in the one embodiment described above are designated by the same reference signs, and detailed description thereof will be omitted, with only the different configurations being described in detail below.

### First modification example

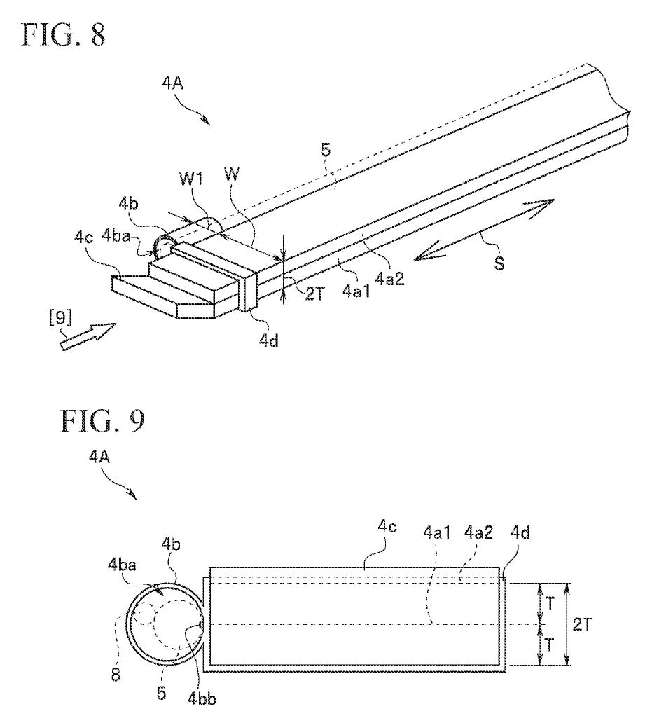

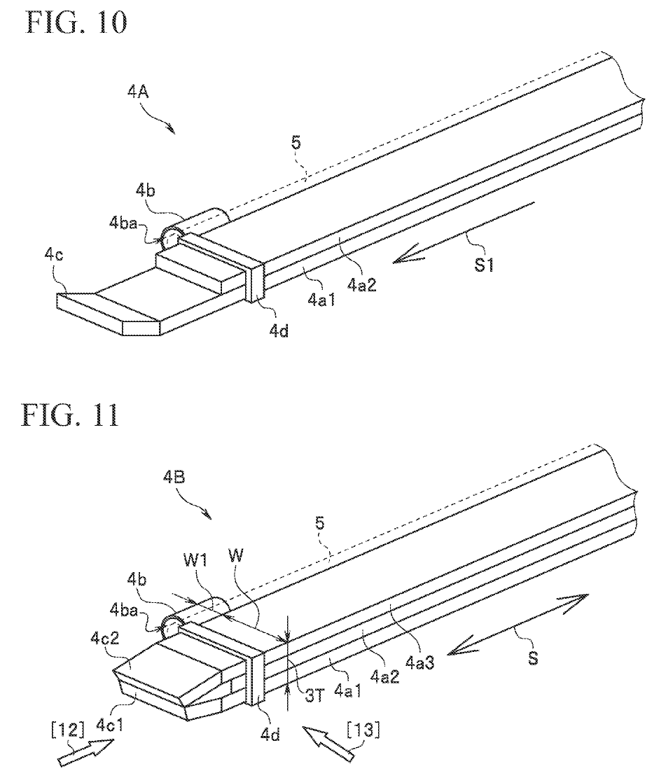

FIGS. 8 to 10 are views showing a first modification example of the insertion guide device according to the one embodiment of the present invention. FIG. 8 is a main part enlarged perspective view showing a part of a distal end region of an insertion guide device according to the first modification example. FIG. 9 is a plan view of the insertion guide device of FIG. 8 as seen from a position in front thereof (in a direction indicated by an arrow [9] in FIG. 8). In addition, FIG. 10 is a view showing an operation of the insertion guide device of FIG. 8.

As shown in FIGS. 8 and 9, an insertion guide device 4A of the first modification example is different from that of the one embodiment in that it has two flat plate-shaped members (4a1, 4a2).

The insertion guide device 4A of the first modification example includes a first flat plate-shaped member 4a1, a second flat plate-shaped member 4a2, and a cylindrical member 4b. Of these, the first flat plate-shaped member 4a1 has substantially the same configuration as the flat plate-shaped member 4a in the one embodiment described above and has a bent portion 4c at a distal end thereof. In addition, the second flat plate-shaped member 4a2 is simply a flat plate obtained by removing the bent portion 4c from the first flat plate-shaped member 4a1.

The first flat plate-shaped member 4a1 and the second flat plate-shaped member 4a2 are stacked in the thickness direction. The two flat plate-shaped members (4a1, 4a2) are bound together at distal end regions thereof using a clamp 4d so as to maintain the stacked state. In this case, the first flat plate-shaped member 4a1 is disposed so as to be slidable relative to the second flat plate-shaped member 4a2 in a direction along an arrow S in FIG. 8.

With this configuration, the insertion guide device 4A of the first modification example has a width W and a thickness T×2 = 2T, and the thickness 2T is smaller than the width W (W > 2T). Here, the thickness T of each of the flat plate-shaped members (4a1, 4a2) may be set to be smaller than the thickness T of the flat plate-shaped member 4a in the one embodiment described above. This allows the overall thickness dimension to be reduced even in a case in which a plurality of flat plate-shaped members are stacked. The other configurations are substantially the same as those of the insertion guide device 4 of the one embodiment described above.

The operation of the insertion guide device 4A of the first modification example formed in this manner is substantially the same as that of the one embodiment described above. Furthermore, in the first modification example, when it is in a first state shown in FIG. 8, it is possible to displace the first flat plate-shaped member 4a1 to a second state shown in FIG. 10 by sliding the first flat plate-shaped member 4a1 in a direction of an arrow S1 in FIG. 10 and moving the first flat plate-shaped member 4a1 a predetermined amount.

As described above, according to the insertion guide device 4A of the first modification example, it is possible to obtain substantially the same effects as those of the one embodiment described above. Furthermore, according to the first modification example, when displaced to the second state, the distal end region can be formed to be more flexible than when in the first state.

In addition, in the first modification example, the flexibility of the distal end region can be adjusted by adjusting the sliding amount of the first flat plate-shaped member 4a1 in the second state.

In the first modification example described above, an example in which two flat plate-shaped members (4a1, 4a2) are used is shown, but for example, a configuration example in which three or more flat plate-shaped members are stacked may be possible. Even in such a configuration, the thickness T is always set to be smaller than the width W.

### Second modification example

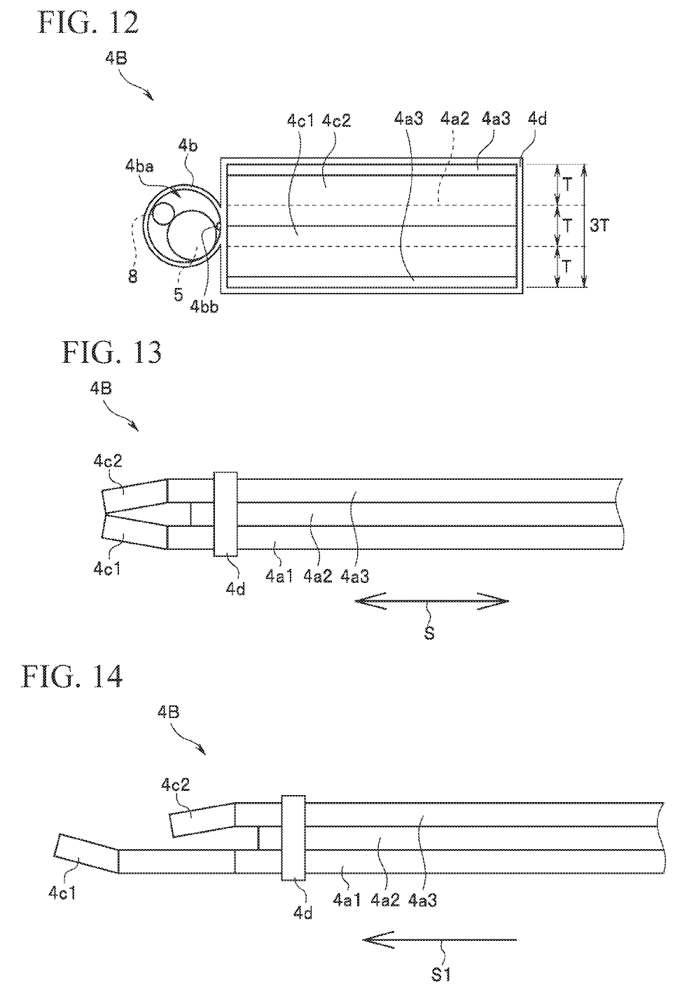

FIGS. 11 to 14 are views showing a second modification example of the insertion guide device according to the one embodiment of the present invention. FIG. 11 is a main part enlarged perspective view showing a part of a distal end region of an insertion guide device according to the second modification example. FIG. 12 is a plan view of the insertion guide device of FIG. 11 as seen from a position in front thereof (in a direction indicated by an arrow [12] in FIG. 11). FIG. 13 is a plan view of the insertion guide device of FIG. 11 as seen from a side thereof (in a direction indicated by an arrow [13] in FIG. 11). In addition, FIG. 14 is a view showing an operation of the insertion guide device of FIG. 11.

As shown in FIG. 11 and the like, an insertion guide device 4B of the second modification example is different from that of the first modification example in that it has three flat plate-shaped members (4a1, 4a2, 4a3).

The insertion guide device 4B of the second modification example includes a first flat plate-shaped member 4a1, a second flat plate-shaped member 4a2, a third flat plate-shaped member 4a3, and a cylindrical member 4b.

Of these, the first flat plate-shaped member 4a1 and the third flat plate-shaped member 4a3 have substantially the same configuration as the first flat plate-shaped member 4a1 of the first modification example described above and have a first bent portion 4c1 and a second bent portion 4c2 at distal ends thereof, respectively.

In addition, the second flat plate-shaped member 4a2 has substantially the same configuration as the second flat plate-shaped member 4a2 of the first modification example described above and is simply a flat plate having no bent portion at a distal end thereof.

The first flat plate-shaped member 4a1, the second flat plate-shaped member 4a2, and the third flat plate-shaped member 4a3 are stacked in the thickness direction. In this case, the second flat plate-shaped member 4a2 is disposed so as to be sandwiched between the first flat plate-shaped member 4a1 and the third flat plate-shaped member 4a3. At this time, the first bent portion 4c1 of the first flat plate-shaped member 4a1 and the second bent portion 4c2 of the third flat plate-shaped member 4a3 are both disposed so as to bend toward a side on which the second flat plate-shaped member 4a2 is located.

The three flat plate-shaped members (4a1, 4a2, 4a3) are bound together at distal end regions thereof using a clamp 4d so as to maintain the stacked state. In this case, the first flat plate-shaped member 4a1 and the third flat plate-shaped member 4a3 are disposed so as to be slidable relative to the second flat plate-shaped member 4a2 in a direction along an arrow S in FIGS. 11 and 13.

With this configuration, the insertion guide device 4B of the second modification example has a width W and a thickness T×3 = 3T, and the thickness 3T is smaller than the width W (W > 3T). The other configurations are substantially the same as those of the insertion guide device 4A of the first modification example described above.

In addition, in the insertion guide device 4B of the second modification example formed in this manner, when it is in a first state shown in FIGS. 11 and 13, it is possible to displace the first flat plate-shaped member 4a1 or the third flat plate-shaped member 4a3 to a second state shown in FIG. 14 by sliding the first flat plate-shaped member 4a1 or the third flat plate-shaped member 4a3 in a direction of an arrow S1 in FIG. 14 and moving the first flat plate-shaped member 4a1 or the third flat plate-shaped member 4a3 a predetermined amount. The state shown in FIG. 14 shows the second state in which the first flat plate-shaped member 4a1 is displaced. Although not shown in the drawings, in a case in which the third flat plate-shaped member 4a3 is displaced, the configuration is substantially the same as that of the above.

The operation of the insertion guide device 4B of the second modification example formed in this manner is substantially the same as that of the first modification example described above.

In the second modification example, when the insertion guide device 4B is inserted into the subject, the insertion guide device is set in the first state shown in FIGS. 11 and 13. In this state, for example, it is assumed that the distal end of the insertion guide device 4B comes into contact with a vertical wall surface. In this case, the first flat plate-shaped member 4a1 is slid in the direction of the arrow S1 in FIG. 14. Then, the insertion guide device 4B is displaced to the second state. At this time, the insertion guide device 4B changes an advancing direction to a bending direction of the bent portion 4c1 of the first flat plate-shaped member 4a1.

Similarly, the third flat plate-shaped member 4a3 is slid in the direction of the arrow S1 in FIG. 14. Then, the insertion guide device 4B displaced to the second state changes an advancing direction to a bending direction of the bent portion 4c2 of the third flat plate-shaped member 4a3.

As described above, according to the insertion guide device 4B of the second modification example, it is possible to obtain substantially the same effects as those of the first modification example described above. Furthermore, according to the second modification example, in a case in which, for example, a vertically branching insertion passage is present in the internal space of the subject, the advancing direction can be selectively set by sliding either the first flat plate-shaped member 4a1 or the third flat plate-shaped member 4a3 when the insertion guide device is displaced to the second state.

### Third modification example

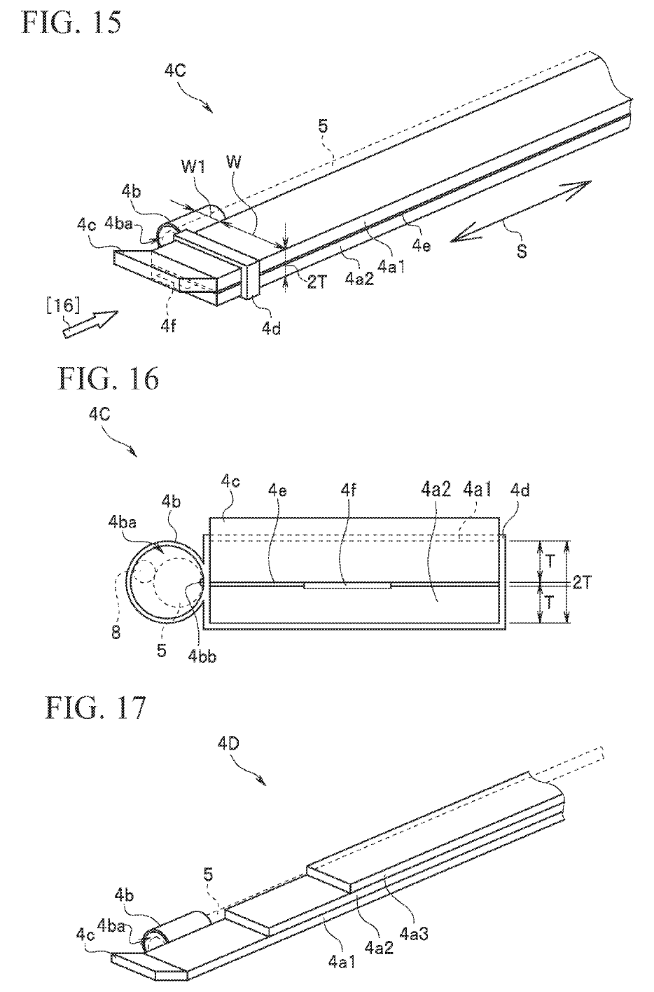

FIGS. 15 and 16 are views showing a third modification example of the insertion guide device according to the one embodiment of the present invention. FIG. 15 is a main part enlarged perspective view showing a part of a distal end region of an insertion guide device according to the third modification example. FIG. 16 is a plan view of the insertion guide device of FIG. 15 as seen from a position in front thereof (in a direction indicated by an arrow [16] in FIG. 15).

As shown in FIGS. 15 and 16, an insertion guide device 4C of the third modification example has two flat plate-shaped members (4a1, 4a2), substantially similar to that of the first modification example described above, but is different from that of the first modification example in that a flexible printed circuit board 4e is disposed between the two flat plate-shaped members (4a1, 4a2).

The insertion guide device 4C of the third modification example includes the first flat plate-shaped member 4a1, the second flat plate-shaped member 4a2, a cylindrical member 4b, and the flexible printed circuit board 4e. Of these, the first flat plate-shaped member 4a1 and the second flat plate-shaped member 4a2 are substantially the same as the two flat plate-shaped members (4a1, 4a2) of the first modification example described above.

In the third modification example, the arrangement of the first flat plate-shaped member 4a1 and the second flat plate-shaped member 4a2 is different from that of the first modification example. The reason for this configuration is to avoid interference between the bent portion 4c and an electric component 4f (which will be described below) disposed at a distal end of the insertion guide device 4C.

The first flat plate-shaped member 4a1 and the second flat plate-shaped member 4a2 are stacked in the thickness direction and are bound together at distal end regions thereof using a clamp 4d. In this case, the first flat plate-shaped member 4a1 is slidable relative to the second flat plate-shaped member 4a2 in a direction along an arrow S in FIG. 15.

The flexible printed circuit board 4e is disposed so as to be sandwiched between the first flat plate-shaped member 4a1 and the second flat plate-shaped member 4a2. An electrode (not shown) extends from a distal end of the flexible printed circuit board 4e, and the electrical component 4f, for example, a temperature sensor, a pressure sensor, or the like, is connected to the electrode. The electrical component 4f is disposed so as to be exposed at a distal end side of the insertion guide device 4C. The other configurations are substantially the same as those of the insertion guide device 4A of the first modification example described above.

The operation of the insertion guide device 4C of the third modification example formed in this manner is substantially the same as that of the first modification example described above.

As described above, according to the insertion guide device 4C of the third modification example, it is possible to obtain substantially the same effects as those of the first modification example described above. Furthermore, according to the third modification example, a temperature sensor, a pressure sensor, or the like can be provided as the electrical component 4f at the distal end of the insertion guide device 4C, making it possible to detect the environmental conditions (environment such as temperature, or the like) inside the subject or the contact pressure when the distal end of the insertion guide device 4C comes into contact with the wall surface or the like.

In addition, sensors are later connected to this flexible printed circuit board 4e to measure physical quantities of the internal environment, and by making the distal end portion a connector, it becomes easy to replace the sensors. Furthermore, the sensor may be integrated into the flexible printed circuit board 4e. It is also possible to measure the shape of the insertion guide device 4C by causing the sensor to be interposed therein, not just the flexible printed circuit board 4e.

### Fourth modification example

FIG. 17 shows a fourth modification example of the insertion guide device according to the one embodiment of the present invention and is a main part enlarged perspective view showing a part of a distal end region of the insertion guide device.

As shown in FIG. 17, an insertion guide device 4D of the fourth modification example is different from that of each modification example described above in the arrangement of three flat plate-shaped members (4a1, 4a2, 4a3).

The insertion guide device 4D of the fourth modification example includes a first flat plate-shaped member 4a1, a second flat plate-shaped member 4a2, a third flat plate-shaped member 4a3, and a cylindrical member 4b.

Of these, the first flat plate-shaped member 4a1 has substantially the same configuration as the first flat plate-shaped member 4a1 of the one embodiment described above and has a first bent portion 4c at a distal end thereof.

In addition, each of the second flat plate-shaped member 4a2 and the third flat plate-shaped member 4a3 has substantially the same configuration as the second flat plate-shaped member 4a2 of the first modification example described above and is simply a flat plate having no bent portion at a distal end thereof.

The first flat plate-shaped member 4a1, the second flat plate-shaped member 4a2, and the third flat plate-shaped member 4a3 are stacked in the thickness direction. In this case, the three flat plate-shaped members (4a1, 4a2, 4a3) are disposed such that their respective end portions are shifted by a predetermined distance in the longitudinal direction. Here, in the three flat plate-shaped members (4a1, 4a2, 4a3), the end portion of the first flat plate-shaped member 4a1 is disposed at a position protruding furthest toward the distal end side, then the end portion of the second flat plate-shaped member 4a2 is disposed to be closer to the proximal end with a predetermined interval, and then the end portion of the third flat plate-shaped member 4a3 is disposed to be closer to the proximal end with a predetermined interval.

In this case, the three flat plate-shaped members (4a1, 4a2, 4a3) are fixed to each other so as to maintain a predetermined positional relationship.

The cylindrical member 4b is disposed on a width direction side surface of the first flat plate-shaped member 4a1 on the proximal end side with respect to the bent portion 4c. The other configurations are substantially the same as those of the insertion guide device 4A of the first modification example described above.

As described above, according to the insertion guide device 4D of the fourth modification example, it is possible to obtain substantially the same effects as those of the one embodiment described above. Furthermore, according to the fourth modification example, fewer plate-shaped members are stacked toward the distal end, and thus greater flexibility can be ensured. This therefore makes it possible to improve the ease of insertion at the bent portion in the internal space of the subject.

In the fourth modification exampled described above, a form in which the three flat plate-shaped members (4a1, 4a2, 4a3) are fixed has been illustrated, but the present invention is not limited to this configuration example. For example, as in the second and third modification examples, a configuration in which the sliding of the plurality of flat plate-shaped members in the longitudinal direction is secured using the clamps 4d may be possible.

### Fifth modification example

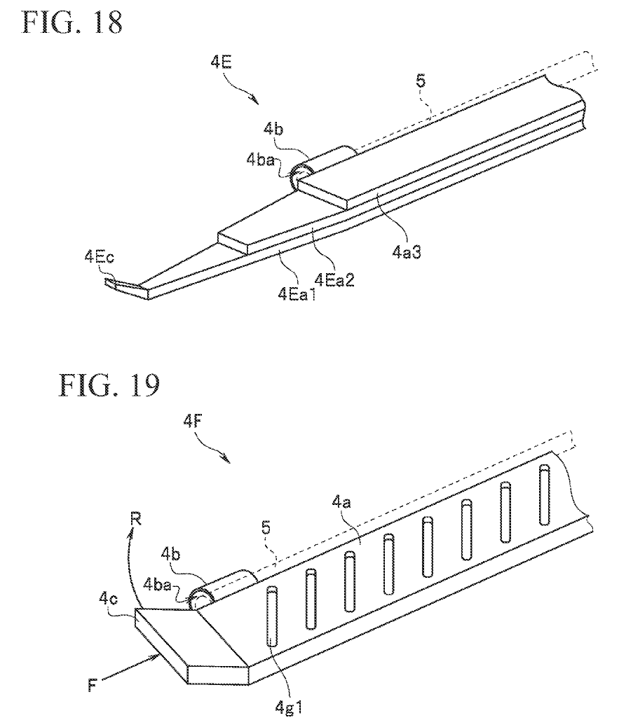

FIG. 18 shows a fifth modification example of the insertion guide device according to the one embodiment of the present invention and is a main part enlarged perspective view showing a part of a distal end region of the insertion guide device.

As shown in FIG. 18, an insertion guide device 4E of the fifth modification example has substantially the same configuration as that of the fourth modification example described above, but is different from that of the fourth modification example described above in the shapes of three flat plate-shaped members (4Ea1, 4Ea2, 4a3).

The insertion guide device 4E of the fifth modification example includes a first flat plate-shaped member 4Ea1, a second flat plate-shaped member 4Ea2, a third flat plate-shaped member 4Ea3, and a cylindrical member 4b.

Of these, the first flat plate-shaped member 4Ea1 and the second flat plate-shaped member 4Ea2 are formed in a tapered shape that narrows toward the distal end side thereof. The first flat plate-shaped member 4Ea1 has a first bent portion 4c at the distal end thereof. In addition, the second flat plate-shaped member 4Ea2 is simply a flat plate with no bent portion at the distal end thereof.

The cylindrical member 4b is disposed on a width direction side surface of a portion of the three stacked flat plate-shaped members (4Ea1, 4Ea2, 4a3) near the distal end thereof. The other configurations are substantially the same as those of the insertion guide device 4D of the fourth modification example described above.

As described above, according to the insertion guide device 4E of the fifth modification example, it is possible to obtain substantially the same effects as those of the fourth modification example described above. Furthermore, according to the fifth modification example, the distal ends of the first flat plate-shaped member 4Ea1 and the second flat plate-shaped member 4Ea2 are formed in a tapered shape, and thus it is possible to ensure greater flexibility than the fourth modification example described above. This therefore makes it possible to contribute to further improving the ease of insertion of the endoscope insertion portion into the subject.

In the fifth modification example described above, the three flat plate-shaped members are not limited to being fixed, and a configuration in which the sliding of the plurality of flat plate-shaped members in the longitudinal direction is secured using the clamps 4d may be possible.

Although the fifth modification example shows a configuration example in which it is constituted by three flat plate-shaped members are provided, the present invention is not limited to this configuration. For example, in the case of a configuration substantially similar to that of the first modification example described above, that is, in the case in which it is constituted by a single flat plate-shaped member, the distal end of the flat plate-shaped member may be formed in a tapered shape.

### Sixth modification example

FIG. 19 shows a sixth modification example of the insertion guide device according to the one embodiment of the present invention and is a main part enlarged perspective view showing a part of a distal end region of the insertion guide device.

As shown in FIG. 19, an insertion guide device 4F of the sixth modification example has substantially the same configuration as that of the one embodiment described above, but is different from that of the one embodiment described above in that it has a plurality of slits 4g1 on a flat surface of a flat plate-shaped member 4Fa.

The insertion guide device 4F of the sixth modification example includes the flat plate-shaped member 4Fa and a cylindrical member 4b. Of these, the flat plate-shaped member 4Fa has a bent portion 4c and the plurality of slits 4g1.

The plurality of slits 4g1 extend in the width direction on the flat surface of the flat plate-shaped member 4Fa and are formed side by side at predetermined intervals in the longitudinal direction within the range of a predetermined region on the distal end side. The plurality of slits 4g1 are formed at a predetermined inclination angle with respect to the longitudinal direction. The other configurations are substantially the same as those of the insertion guide device 4 of the one embodiment described above.

The operation of the insertion guide device 4F of the sixth modification example formed in this manner is schematically as follows. For example, it is assumed that a pressing force is applied to the distal end portion of the bent portion 4c in a direction of an arrow F shown in FIG. 19. That is, it is assumed that the distal end of the insertion guide device 4F comes into contact with a vertical wall surface inside the subject and is pushed therein.

In this way, when a pressing force in the direction of the arrow F is applied to the distal end of the bent portion 4c, the insertion guide device 4F is bent at an angle in a direction of an arrow R, for example. Furthermore, the insertion guide device 4F is bent at an angle in the direction of the arrow R in FIG. 19 due to the plurality of slits 4g1 formed at an inclination angle.

The insertion guide device 4F of the sixth modification example, which has such an operation, is suitable for observing and inspecting a structure that is formed in the internal space of the subject obliquely in the left and right width direction (the X-axis direction) with respect to the advancing direction, for example.

As described above, according to the insertion guide device 4F of the sixth modification example, it is possible to obtain substantially the same effects as those of the one embodiment described above. Furthermore, according to the sixth modification example, insertion can be performed more efficiently into a specific structure in the internal space of the subject, for example, a structure formed obliquely in the left and right width direction (the X-axis direction) with respect to the advancing direction.

### Seventh modification example

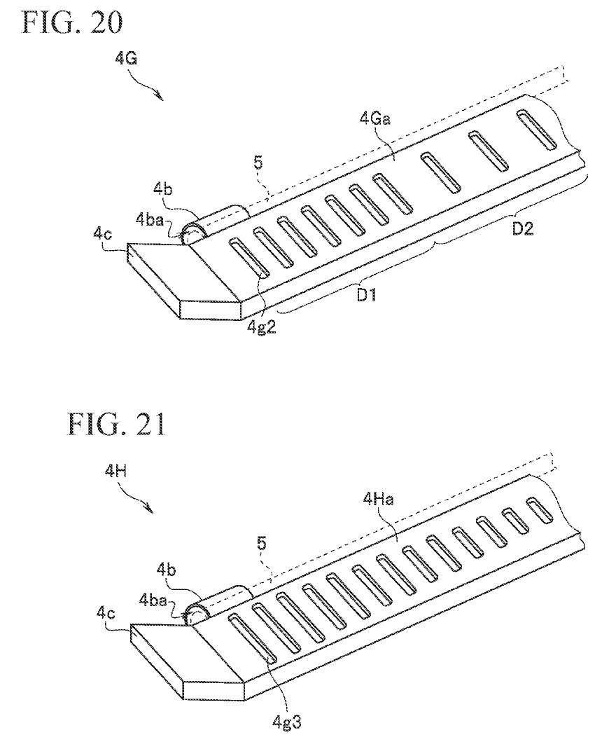

FIG. 20 shows a seventh modification example of the insertion guide device according to the one embodiment of the present invention and is a main part enlarged perspective view showing a part of a distal end region of the insertion guide device.

As shown in FIG. 20, an insertion guide device 4G of the seventh modification example has substantially the same configuration as that of the sixth modification example described above, but is different from that of the sixth modification example described above in the forms of a plurality of slits provided on a flat surface of a flat plate-shaped member.

The insertion guide device 4G of the seventh modification example includes a flat plate-shaped member 4Ga and a cylindrical member 4b. Of these, the flat plate-shaped member 4Ga has a bent portion 4c and a plurality of slits 4g2.

The plurality of slits 4g2 are formed on the flat surface of the flat plate-shaped member 4Ga side by side at predetermined intervals in the longitudinal direction within the range of a predetermined region on the distal end side.

Here, within the range of the region in which the plurality of slits 4g2 are formed, for example, a region in a predetermined range on the distal end side is designated as a first region D1, and a region in a predetermined range on the proximal end side with respect to the first region D1 is designated as a second region D2 (see FIG. 20).

In this case, the arrangement interval between the plurality of slits 4g2 formed in the first region D1 is set to be narrower than the arrangement interval between the plurality of slits 4g2 formed in the second region D2. The other configurations are substantially the same as those of the insertion guide device 4F of the sixth modification example described above.

As described above, according to the insertion guide device 4G of the seventh modification example, it is possible to obtain substantially the same effects as those of the one embodiment described above. Furthermore, according to the seventh modification example, the structure can be made more bendable toward the distal end, as a result, it is possible to contribute to improving the ease of insertion.

### Eighth modification example

FIG. 21 shows an eighth modification example of the insertion guide device according to the one embodiment of the present invention and is a main part enlarged perspective view showing a part of a distal end region of the insertion guide device.

As shown in FIG. 21, an insertion guide device 4H of the eighth modification example has substantially the same configuration as that of the seventh modification example described above, but is different from that of the seventh modification example described above in the forms of a plurality of slits provided on a flat surface of a flat plate-shaped member.

The insertion guide device 4H of the eighth modification example includes a flat plate-shaped member 4Ha and a cylindrical member 4b. Of these, the flat plate-shaped member 4Ha has a bent portion 4c and a plurality of slits 4g3.

The plurality of slits 4g3 are formed on the flat surface of the flat plate-shaped member 4Ha side by side at predetermined intervals in the longitudinal direction within the range of a predetermined region on the distal end side.

Furthermore, the plurality of slits 4g3 in the eighth modification example are set such that the width direction dimension gradually narrows from the distal end side toward the proximal end side. The other configurations are substantially the same as those of the insertion guide device 4F of the sixth modification example described above.

As described above, according to the insertion guide device 4H of the eighth modification example, it is possible to obtain substantially the same effects as those of the seventh modification example described above. Furthermore, according to the eighth modification example, it is possible to bend the flat plate member smoothly from the distal end to the proximal end compared to the seventh modification example described above. As a result, it is possible to contribute to further improving the ease of insertion.

### Ninth Modification example

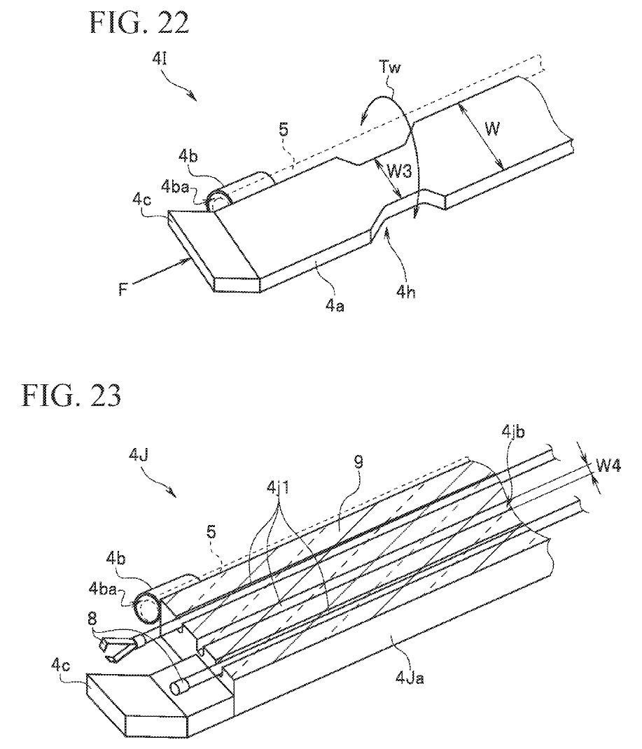

FIG. 22 shows a ninth modification example of the insertion guide device according to the one embodiment of the present invention and is a main part enlarged perspective view showing a part of a distal end region of the insertion guide device.

As shown in FIG. 22, an insertion guide device 4I of the ninth modification example has substantially the same configuration as that of the one embodiment described above, but is different from that of the one embodiment described above in the shape of a flat plate-shaped member.

The insertion guide device 4I of the ninth modification example includes a flat plate-shaped member 4Ia and a cylindrical member 4b. Of these, the flat plate-shaped member 4Ia has a bent portion 4c and a constricted portion 4h.

The constricted portion 4h is formed in a predetermined region near the distal end of the flat plate-shaped member 4Ia. The constricted portion 4h is formed by cutting out a partial region on both sides of the flat plate-shaped member 4Ia in the width direction. Here, the constricted portion 4h makes the width W of the flat plate-shaped member 4Ia a narrow region (a width W3) (W > W3).

With this configuration, in the insertion guide device 4I, for example, when a force greater than a predetermined amount is applied to the distal end in a predetermined direction, the flat plate-shaped member 4Ia has a structure that is prone to twisting at the constricted portion 4h as shown by an arrow Tw in FIG. 22.

Here, the predetermined direction is assumed to be, for example, a direction of rotation around the longitudinal direction in addition to a force in the longitudinal direction of the flat plate-shaped member 4Ia. The other configurations are substantially the same as those of the insertion guide device 4 of the one embodiment described above.

The operation of the insertion guide device 4I of the ninth modification example formed in this manner is schematically as follows. For example, it is assumed that a pressing force is applied to the distal end portion of the bent portion 4c in a direction of an arrow F shown in FIG. 22. Here, the direction of the arrow F is a direction in the longitudinal direction of the flat plate-shaped member 4Ia. That is, it is assumed that the distal end of the insertion guide device 4I comes into contact with a vertical wall surface inside the subject and is pushed therein.

In this way, when a pressing force in the direction of the arrow F is applied to the distal end portion of the bent portion 4c, the insertion guide device 4I start bending in a bending direction of the bent portion 4c.

Here, a case in which the wall surface with which the distal end of the insertion guide device 4I is in contact is formed, for example, in a curved shape, and an insertion passage is bent in a perpendicular direction and then is further bent in a different direction to form a so-called twisted structure is considered. At this time, the insertion passage is maintained in a state in which the dimension thereof in the thickness direction is narrow. A specific example of such an internal structure in the subject is an exhaust duct installed in a building or the like.

During such an observation and inspection of the inside of the subject, when the distal end portion of the insertion guide device 4I receives a pressing force in the direction of the arrow F, the distal end of the bent portion 4c tries to advance along the wall surface having a curved shape. However, there is a high possibility that the insertion guide device 4I will not be able to pass through a portion at which the insertion passage is twisted.

Therefore, in the insertion guide device 4I of the ninth modification example, the constricted portion 4h is provided, and thus the flat plate-shaped member 4Ia can be easily twisted at a predetermined portion. For this reason, under the internal conditions of the twisted structure described above, the flat plate-shaped member 4Ia of the insertion guide device 4I of the ninth modification example is easily twisted at the constricted portion 4h. Therefore, even in the insertion passage having a specific structure of a form described above, the insertion guide device 4I of the ninth modification example ensures smooth insertion and allows efficient insertion.

As described above, according to the insertion guide device 4I of the ninth modification example, it is possible to obtain substantially the same effects as those of the one embodiment described above. Furthermore, according to the ninth modification example, it is possible to suitably address the specific structure (the insertion passage of a form in which the bending direction is changed according to the wall surface having the curved shape, or the like) in the internal space of the subject.

### Tenth modification example

FIG. 23 shows a tenth modification example of the insertion guide device according to the one embodiment of the present invention and is a main part enlarged perspective view showing a part of a distal end region of the insertion guide device.

As shown in FIG. 23, an insertion guide device 4J of the tenth modification example has substantially the same configuration as that of the one embodiment described above, but is different from that of the one embodiment described above in that it has a plurality of long grooves slits 4j1, which are holding members, on a flat surface of a flat plate-shaped member 4Ja.

The insertion guide device 4J of the tenth modification example includes the flat plate-shaped member 4Ja and a cylindrical member 4b. Of these, the flat plate-shaped member 4Ja has a bent portion 4c and the plurality of long grooves 4j1.

The plurality of long grooves 4j1 are grooves formed in the longitudinal direction on the flat surface of the flat plate-shaped member 4Ja. The plurality of long grooves 4j1 have groove openings 4jb facing upward on the flat surface of the flat plate-shaped member 4Ja. The plurality of long grooves 4j1 are formed side by side at predetermined intervals in the width direction of the flat plate-shaped member 4Ja. A groove width W4 of each long groove 4j1 is set to a dimension that allows one of various treatment tools and the like 8 to be disposed in the long groove, for example. This allows one of the treatment tools and the like 8 to be easily disposed inside the long groove 4j1 through the groove opening 4jb.

After one of the treatment tools and the like 8 is disposed in the long groove 4j1, a film-like member 9 that covers the groove opening 4jb of the long groove 4j1 is disposed on the surface of the flat surface portion of the flat plate-shaped member 4Ja. As a result, the film-like member 9 prevents one of the treatment tools and the like 8 disposed in each long groove 4j1 from falling off from the groove opening 4jb.

With this configuration, in the insertion guide device 4J, one of the treatment tools and the like 8 disposed in each long groove 4j1 is disposed to be freely advanced and retreated in the longitudinal direction while being prevented from falling off from the groove opening 4jb. The other configurations are substantially the same as those of the insertion guide device 4 of the one embodiment described above.

As described above, according to the insertion guide device 4J of the tenth modification example, it is possible to obtain substantially the same effects as those of the one embodiment described above. Furthermore, according to the tenth modification example, it is possible to reliably hold the treatment tools and the like 8, in addition to the insertion portion 5 of the endoscope. This therefore makes it possible to reliably and efficiently guide the insertion portion 5 or the treatment tools and the like 8 to a desired portion inside the subject.

In addition, since the long groove 4j1 is formed in the longitudinal direction of the flat plate-shaped member 4Ja, it is possible to arrange the endoscope or the treatment tool and the like having a thin and slender tube shape over a long range from the distal end to the vicinity of the proximal end, thereby enabling the endoscope or the treatment tool and the like to be held more securely.

In the configuration example of the tenth modification example, an example in which three long grooves 4j1 are provided has been illustrated, but the present invention is not limited to this configuration example, and the number of long grooves 4j1 to be disposed can be appropriately selected and set.

In addition, in the tenth modification example, similar to the one embodiment and each modification example described above, the cylindrical member 4b is provided to fix the distal end of the insertion portion 5, but the present invention is not limited to this configuration example. For example, by appropriately adjusting the setting of the width W4 of the long groove 4j1, it is possible to make the insertion portion 5 of the endoscope be disposed in the long groove 4j1. In the case of such a configuration, the cylindrical member 4b can be omitted. As a result, it is possible to contribute to the miniaturization of the insertion guide device.

### Eleventh modification example

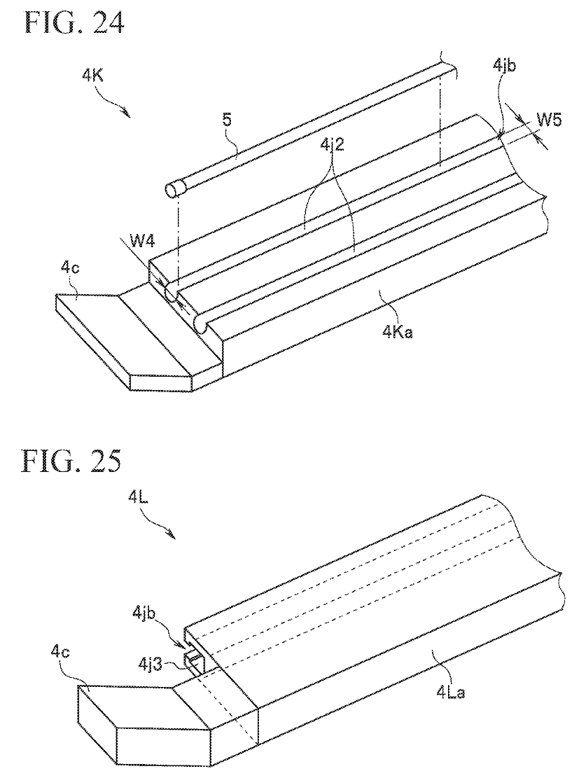

FIG. 24 shows an eleventh modification example of the insertion guide device according to the one embodiment of the present invention and is a main part enlarged perspective view showing a part of a distal end region of the insertion guide device.

As shown in FIG. 24, an insertion guide device 4K of the eleventh modification example has substantially the same configuration as that of the tenth modification example described above, but is slightly different from that of the tenth modification example described above in the shapes of a plurality of long grooves, which are holding members.

In the insertion guide device 4K of the eleventh modification example, a plurality of long grooves 4j2 are formed in the longitudinal direction on the flat surface of a flat plate-shaped member 4Ka, substantially similar to those of the tenth modification example. The plurality of long grooves 4j2 are formed side by side at predetermined intervals in the width direction of the flat plate-shaped member 4Ka. Here, a groove width W5 of each long groove 4j2 is set to a dimension that allows an insertion portion 5 of an endoscope or one of various treatment tools and the like 8 to be disposed in the long groove, for example.

On the other hand, the width W5 of a groove opening 4jb of each long groove 4j2 is set to be smaller than the groove width W4 of each long groove 4j2 (W4 > W5). In this case, at least the peripheral edge region of the long groove 4j2 of the flat plate-shaped member 4Ka is formed of, for example, an elastic resin member.

With this configuration, when one of the treatment tools and the like 8 is disposed in each long groove 4j2, in a state in which one of the treatment tools and the like 8 is placed against the groove opening 4jb, if a predetermined amount of pressing force is applied to the entire side surface of the insertion portion 5, the groove opening 4jb opens against the pressing force, and one of the treatment tools and the like 8 is fitted into the long groove 4j2.

One of the treatment tools and the like 8 fitted and disposed in the long groove 4j2 in this way is disposed to be freely advanced and retreated in the longitudinal direction while being prevented from falling off from the groove opening 4jb. By adopting such a configuration, in the configuration of the eleventh modification example, the film-like member 9 in the tenth modification example described above can be omitted. The other configurations are substantially the same as those of the insertion guide device 4J of the tenth modification example described above.

As described above, according to the insertion guide device 4K of the eleventh modification example, it is possible to obtain substantially the same effects as those of the tenth modification example described above. Furthermore, according to the eleventh modification example, it is possible to more reliably hold the insertion portion 5 or the treatment tools and the like 8 without using the film-like member 9.

In the configuration example of the eleventh modification example, an example in which two long grooves 4j2 are provided has been illustrated, but the present invention is not limited to this configuration example, and the number of long grooves 4j2 to be disposed can be appropriately selected and set.

### Twelfth modification example

FIG. 25 shows a twelfth modification example of the insertion guide device according to the one embodiment of the present invention and is a main part enlarged perspective view showing a part of a distal end region of the insertion guide device.

As shown in FIG. 25, an insertion guide device 4L of the twelfth modification example has substantially the same configuration as that of the eleventh modification example described above, but is different from that of the eleventh modification example described above in the form of a long groove, which is a holding member.

In the insertion guide device 4L of the twelfth modification example, a long groove 4j3 is formed in the longitudinal direction on a width direction side surface of a flat plate-shaped member 4La. A groove width of the long groove 4j3 is set to a dimension that allows an insertion portion of an endoscope or various treatment tools and the like to be disposed in the long groove, similar to that of the eleventh modification example described above.

On the other hand, the width of a groove opening 4jb of the long groove 4j3 is set to be smaller than the groove width of the long groove 4j3. At least the peripheral edge region of the long groove 4j3 of the flat plate-shaped member 4La is formed of, for example, an elastic resin member.

In the twelfth modification example, a bent portion 4c is disposed slightly closer to the distal end than the distal end of the flat plate-shaped member 4La. This is a measure to ensure the flexibility of a region near the distal end of the flat plate-shaped member 4La, including the bent portion 4c. The other configurations are substantially the same as those of the insertion guide device 4K of the eleventh modification example described above.

With this configuration, a treatment tool and the like can be easily fitted and disposed in the long groove 4j3 due to the same operation as in the eleventh modification example described above.

As described above, according to the insertion guide device 4L of the twelfth modification example, it is possible to obtain substantially the same effects as those of the eleventh modification example described above. Furthermore, according to the twelfth modification example, the long groove 4j3 is disposed on the width direction side surface of the flat plate-shaped member 4La and is formed in the longitudinal direction, and thus it is possible to reduce a dimension in the thickness direction.

### Thirteenth modification example

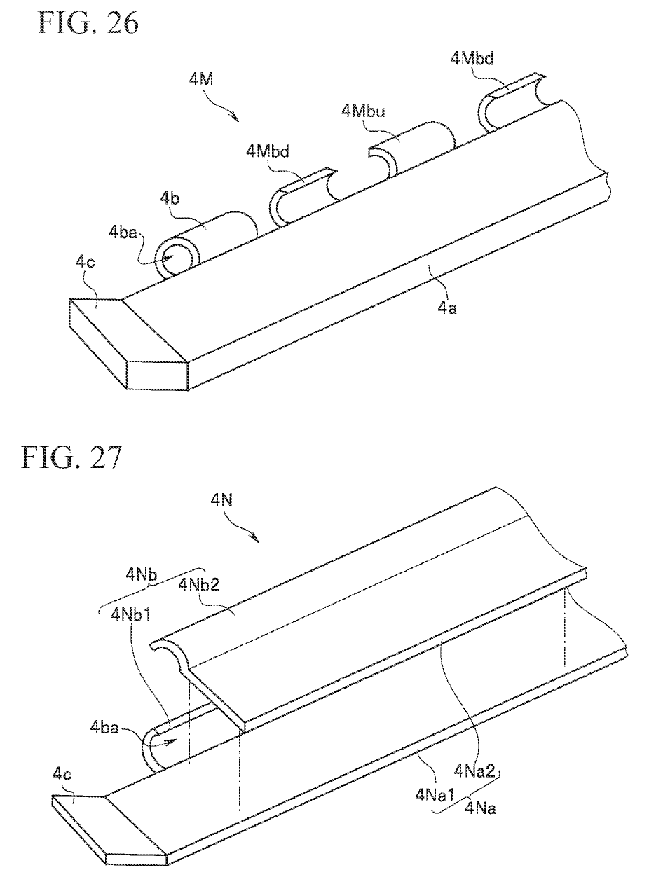

FIG. 26 shows a thirteenth modification example of the insertion guide device according to the one embodiment of the present invention and is a main part enlarged perspective view showing a part of a distal end region of the insertion guide device.

As shown in FIG. 26, an insertion guide device 4M of the thirteenth modification example has substantially the same configuration as that of the one embodiment described above, but is different from that of the one embodiment described above in the form of a holding member.

The insertion guide device 4M of the thirteenth modification example includes a flat plate-shaped member 4a and a holding member. The flat plate-shaped member 4a has the same configuration as that of the one embodiment described above.

The holding member is made up of a cylindrical member 4b and a plurality of semi-cylindrical members 4Mbd and 4Mbu. The cylindrical member 4b has the same configuration as that of the one embodiment described above.

The semi-cylindrical members 4Mbd and 4Mbu are each formed by cutting the cylindrical member 4b along a plane along a longitudinal axis. Of these, the semi-cylindrical member 4Mbd corresponds to a portion that forms a lower half of the cylindrical member 4b when viewed from a position in front thereof. Similarly, the semi-cylindrical member 4Mbu corresponds to a portion that forms an upper half of the cylindrical member 4b when viewed from a position in front thereof.

The semi-cylindrical members 4Mbd and 4Mbu are alternately disposed at predetermined intervals in the longitudinal direction of the flat plate-shaped member 4a on the width direction side surface of the flat plate-shaped member 4a.

With this configuration, a distal end of an insertion portion 5 is held by the cylindrical member 4b, and a region in a predetermined range on the proximal end side of the insertion portion 5 is held by the semi-cylindrical members 4Mbd and 4Mbu.

In the thirteenth modification example, the cylindrical member 4b is disposed slightly closer to the proximal end than the distal end of the flat plate-shaped member 4a. This is a measure to ensure the flexibility of a region near the distal end of the flat plate-shaped member 4a, including the bent portion 4c. The other configurations are substantially the same as those of the insertion guide device 4 of the one embodiment described above.

As described above, according to the insertion guide device 4M of the thirteenth modification example, it is possible to obtain substantially the same effects as those of the twelfth modification example described above. Furthermore, according to the thirteenth modification example, the distal end of the insertion portion 5 is held by the cylindrical member 4b, and a portion of the insertion portion 5 on the proximal end side with respect to this cylindrical member 4b is held by the semi-cylindrical members 4Mbd and 4Mbu, and thus, compared to the case in which the insertion portion 5 is disposed by inserting the insertion portion 5 through a tubular member, for example, the insertion portion 5 can be disposed more easily and quickly from the distal end to near the proximal end.

### Fourteenth modification example

FIG. 27 shows a fourteenth modification example of the insertion guide device according to the one embodiment of the present invention and is a main part enlarged perspective view showing a part of a distal end region of the insertion guide device.

As shown in FIG. 27, an insertion guide device 4N of the fourteenth modification example has substantially the same configuration as that of the thirteenth modification example described above, but is different from that of the thirteenth modification example described above in the forms of a flat plate-shaped member and a holding member.

In the insertion guide device 4N of the fourteenth modification example, the flat plate-shaped member 4Na is made up of two plate members (4Na1, 4Na2). The two plate members (4Na1, 4Na2) are joined together at predetermined flat surfaces to form a single flat plate-shaped member 4Na.

The two plate members (4Na1, 4Na2) are made up of a first plate member 4Na1 and a second plate member 4Na2. The first plate member 4Na1 has a bent portion 4c at the distal end thereof. In addition, the first plate member 4Na1 has a first semi-cylindrical portion 4Nb1 that forms part of the holding member and is integrally formed on the side surface thereof.

The first plate member 4Na1 and the first semi-cylindrical portion 4Nb1 may be formed separately. In this case, the first plate member 4Na1 and the first semi-cylindrical portion 4Nb1 are integrated together using a bonding means such as an adhesive.

On the other hand, the second plate member 4Na2 has a second semi-cylindrical portion 4Nb2 that forms part of the holding member and is integrally formed on the side surface thereof. The second plate member 4Na2 and the second semi-cylindrical portion 4Nb2 may be formed separately. In this case, the second plate member 4Na2 and the second semi-cylindrical portion 4Nb2 are integrated together using a means such as an adhesive.

The first plate member 4Na1 and the second plate member 4Na2 are joined together at their flat surface portions to form a flat plate-shaped member 4Na and a cylindrical member 4Nb. At this time, the cylindrical member 4Nb has a through hole 4ba formed therein, which passes through from the distal end to the proximal end thereof. An insertion portion of an endoscope or, if necessary, a treatment tool and the like are disposed in the through hole 4ba.

In the fourteenth modification example, the cylindrical member 4Nb is disposed slightly closer to the proximal end than the distal end of the flat plate-shaped member 4Na. This is a measure to ensure the flexibility of a region near the distal end of the flat plate-shaped member 4Na, including the bent portion 4c. The other configurations are substantially the same as those of the insertion guide device 4M of the thirteenth modification example described above.

As described above, according to the insertion guide device 4N of the fourteenth modification example, it is possible to obtain substantially the same effects as those of the twelfth modification example described above. Furthermore, according to the fourteenth modification example, compared to the case in which the insertion portion 5 is disposed by inserting the insertion portion 5 through a tubular member, for example, the insertion portion 5 can be disposed more easily and quickly from the distal end to near the proximal end.

### Fifteenth modification example

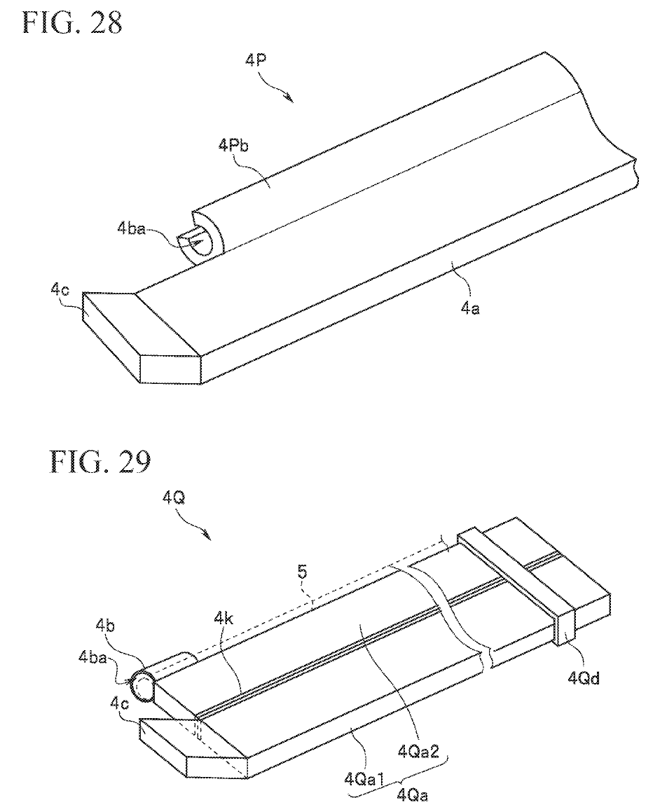

FIG. 28 shows a fifteenth modification example of the insertion guide device according to the one embodiment of the present invention and is a main part enlarged perspective view showing a part of a distal end region of the insertion guide device.

As shown in FIG. 28, an insertion guide device 4P of the fifteenth modification example has substantially the same configuration as that of the one embodiment described above, but is different from that of the one embodiment described above in the form of a holding member.

The insertion guide device 4P of the fifteenth modification example includes a flat plate-shaped member 4a and a cylindrical member 4Pb. The flat plate-shaped member 4a has the same configuration as that of the one embodiment described above. The cylindrical member 4Pb is disposed in a predetermined range from near the distal end to near the proximal end of the flat plate-shaped member 4a in the longitudinal direction on the width direction side surface of the flat plate-shaped member 4a. The cylindrical member 4Pb is formed integrally with the flat plate-shaped member 4a.

The flat plate-shaped member 4a and the cylindrical member 4Pb may be formed separately. In this case, the flat plate-shaped member 4a and the cylindrical member 4Pb are integrated together using a bonding means such as an adhesive.

The cylindrical member 4Pb has a through hole 4ba formed therein, which passes through from the distal end to the proximal end. An insertion portion of an endoscope or, if necessary, a treatment tool and the like are disposed in the through hole 4ba.

In the fifteenth modification example, the cylindrical member 4Pb is disposed slightly closer to the proximal end than the distal end of the flat plate-shaped member 4a. This is a measure to ensure the flexibility of a region near the distal end of the flat plate-shaped member 4a, including the bent portion 4c. The other configurations are substantially the same as those of the insertion guide device 4 of the one embodiment described above.

As described above, according to the insertion guide device 4P of the fifteenth modification example, it is possible to obtain substantially the same effects as those of the one embodiment described above. Furthermore, according to the fifteenth modification example, it is possible to obtain substantially the same effects as those of the twelfth to fourteenth modification examples described above.

### Sixteenth modification example

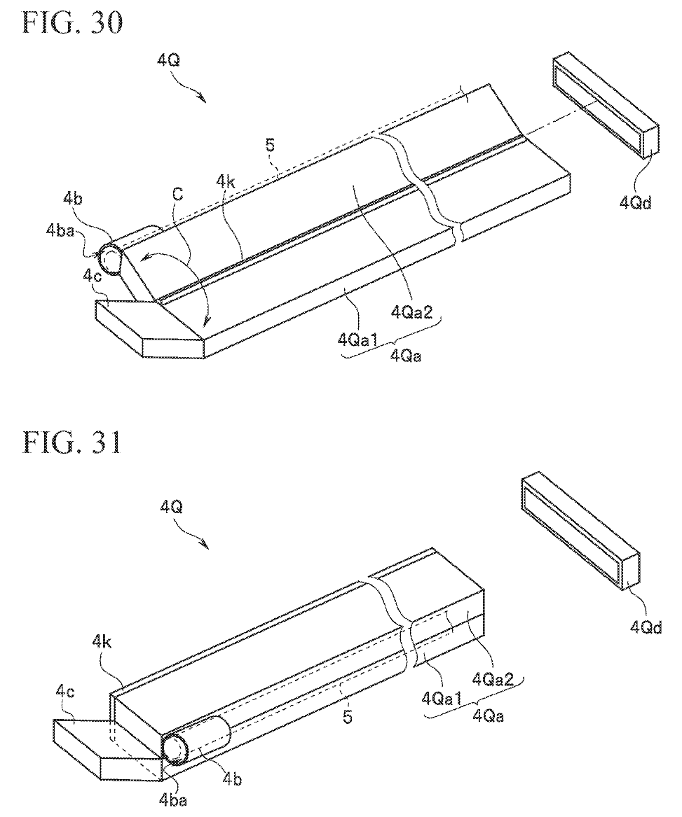

FIGS. 29 to 31 are views showing a sixteenth modification example of the insertion guide device according to the one embodiment of the present invention. Of these, FIG. 29 is a perspective view showing a schematic configuration of the insertion guide device. FIGS. 30 and 31 are schematic views showing a folding process of the insertion guide device of FIG. 29. FIG. 30 shows a state in the middle of the folding process, and FIG. 31 shows a state in which the folding is completed.

As shown in FIG. 29, an insertion guide device 4Q of the sixteenth modification example has substantially the same configuration as that of the one embodiment described above, but is different from that of the one embodiment described above in that the form of the flat plate-shaped member is a foldable type.

The insertion guide device 4Q of the sixteenth modification example includes a flat plate-shaped member 4Qa, a cylindrical member 4b, and a proximal end clamp 4Qd. Of these, the flat plate-shaped member 4Qa is made up of two plate members (4Qa1, 4Qa2). The two plate members (4Qa1, 4Qa2) are formed by dividing the flat plate-shaped member 4Qa in two at approximately the central portion in the width direction. The two plate members (4Qa1, 4Qa2) are connected to each other by a film member 4k, which allows the plate members to be foldable.

That is, in this case, the two plate members (4Qa1, 4Qa2) are connected to each other by the film member 4k and rotate relative to each other in a direction of an arrow C shown in FIG. 30. This allows the two plate members (4Qa1, 4Qa2) to be folded.

The flat plate-shaped member 4Qa, which is made up of the two plate members (4Qa1, 4Qa2) connected to each other by the film member 4k, has the proximal end clamp 4Qd disposed near the proximal end portion in a deployed state. The proximal end clamp 4Qd is formed in a hollow rectangular shape and is disposed on the outer periphery of the proximal ends of the two plate members (4Qa1, 4Qa2) in the deployed state. As a result, the proximal end clamp 4Qd holds the deployed state of the two plate members (4Qa1, 4Qa2).

The two plate members (4Qa1, 4Qa2) are made up of a first plate member 4Qa1 and a second plate member 4Qa2. The first plate member 4Qa1 has a bent portion 4c at the distal end thereof. In addition, the second plate member 4Qa2 has the cylindrical member 4b, which is a holding member, integrally disposed on the side surface thereof.

In this case, the bent portion 4c and the cylindrical member 4b are disposed such that they do not interfere with each other when the two plate members (4Qa1, 4Qa2) are folded, whether they are in the state in the middle of the folding process (see FIG. 30) or in the state in which the folding is finally completed (see FIG. 31). The other configurations are substantially the same as those of the insertion guide device 4 of the one embodiment described above.

The insertion guide device 4Q of the sixteenth modification example having such a configuration can be used in two forms of a wide state in which the two plate members (4Qa1, 4Qa2) are spread out and a narrow state in which the two plate members (4Qa1, 4Qa19/344,814) are folded.

As described above, according to the insertion guide device 4Q of the sixteenth modification example, it is possible to obtain substantially the same effects as those of the one embodiment described above. Furthermore, according to the sixteenth modification example, the flat plate-shaped member 4Qa is configured to be freely foldable, and thus it can be used in two forms of the wide state and the narrow state, and the appropriate state of use can be selected depending on the internal condition of the subject. In addition, the folded state contributes to compactness when it is stored.

### Seventeenth modification example

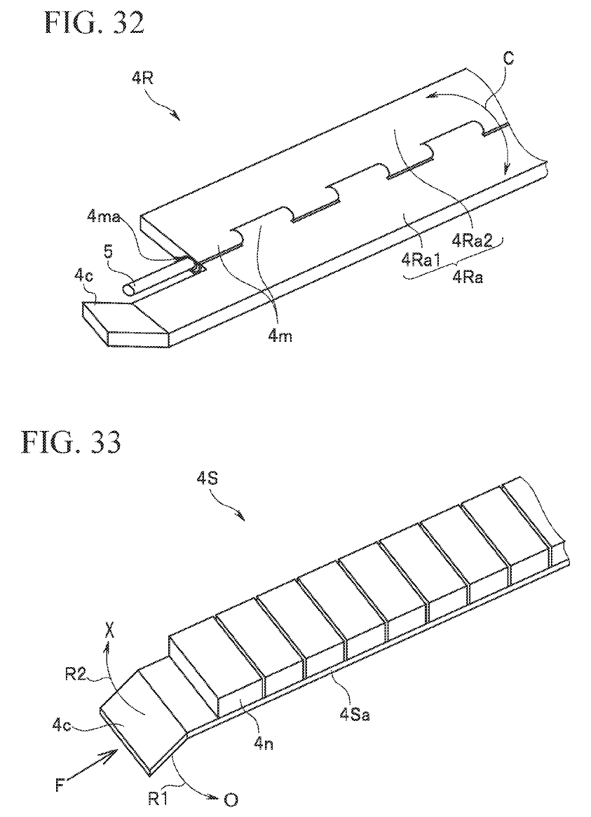

FIG. 32 shows a seventeenth modification example of the insertion guide device according to the one embodiment of the present invention and is a main part enlarged perspective view showing a part of a distal end region of the insertion guide device.

As shown in FIG. 32, an insertion guide device 4R of the seventeenth modification example has substantially the same configuration as that of the sixteenth modification example described above, but is different from that of the sixteenth modification example described above in the forms of a flat plate-shaped member and a holding member.

The insertion guide device 4R of the seventeenth modification example has a flat plate-shaped member 4Ra that is made up of two plate members (4Ra1, 4Ra2). The two plate members (4Ra1, 4Ra2) are formed by dividing the flat plate-shaped member 4Ra in two at approximately the central portion in the width direction. The two plate members (4Ra1, 4Ra2) are connected to each other by a hinge portion 4m. As a result, the two plate members (4Ra1, 4Ra2) are connected to each other by the hinge portion 4m and rotate relative to each other in a direction of an arrow C shown in FIG. 32. This allows the two plate members (4Ra1, 4Ra2) to be folded.

When the flat plate-shaped member 4Ra, which is made up of the two plate members (4Ra1, 4Ra2) connected to each other by the hinge portion 4m, is in a deployed state, the deployed state of the two plate members (4Ra1, 4Ra2) is held by a locking mechanism (not shown) (for example, a known fixing means using a click-stop mechanism, a snap-fit mechanism, or the like).

The two plate members (4Ra1, 4Ra2) are made up of a first plate member 4Ra1 and a second plate member 4Ra2. The first plate member 4Ra1 has a bent portion 4c at the distal end thereof. In addition, a through hole 4ma, which passed through from the distal end to the proximal end of the flat plate-shaped member 4Ra, is formed in the hinge portion 4m. An endoscope or a treatment tool and the like (not shown) are disposed in the through hole 4ma. For this reason, in the seventeenth modification example, the cylindrical member 4b is not provided. The other configurations are substantially the same as those of the insertion guide device 4Q of the sixteenth modification example described above.

As described above, according to the insertion guide device 4R of the seventeenth modification example, it is possible to obtain substantially the same effects as those of the one embodiment described above. Furthermore, according to the seventeenth modification example, the flat plate-shaped member 4Ra is configured to be freely foldable, the through hole 4ba is provided in the hinge portion 4m for realizing the folding configuration, and the endoscope or the treatment tool is disposed in the through hole 4ba, as a result, it is possible to contribute to the miniaturization of the insertion guide device 4R.

### Eighteenth modification example

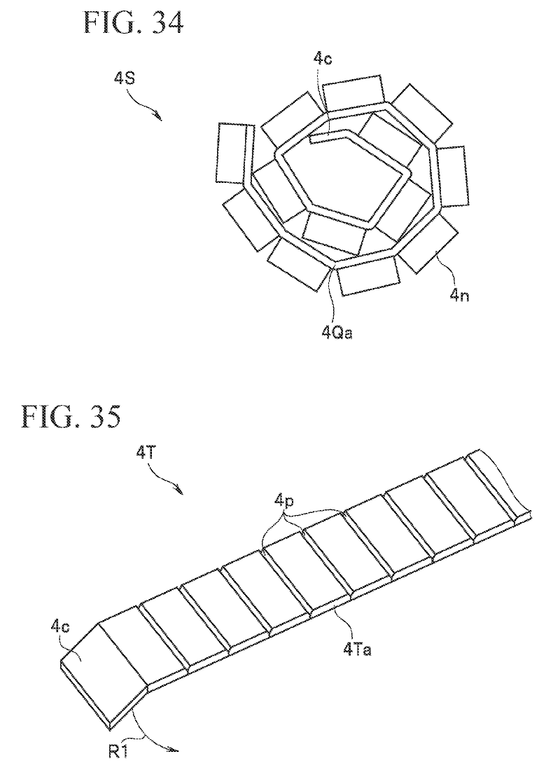

FIG. 33 Shows an eighteenth modification example of the insertion guide device according to the one embodiment of the present invention and is a main part enlarged perspective view showing a part of distal end region of the insertion guide device. FIG. 34 is a view showing the operation of the insertion guide device of the eighteenth modification example when it is stored.

As shown in FIG. 33, an insertion guide device 4S of the eighteenth modification example has substantially the same configuration as that of the one embodiment described above, but is different from that of the one embodiment described above in the form of a flat plate-shaped member. In FIGS. 33 and 34, a cylindrical member has the same configuration as that of the one embodiment and is therefore not shown.

The insertion guide device 4S of the eighteenth modification example includes a flat plate-shaped member 4Sa, a cylindrical member (not shown), and a plurality of plate-shaped blocks 4n.

As the flat plate-shaped member 4Sa, a thin plate member formed of a band-shaped flat plate is adopted. By using the thin plate member, flexibility in the thickness direction is ensured to a greater extent.

The flat plate-shaped member 4Sa has a bent portion 4c at the distal end thereof. The plurality of plate-shaped blocks 4n are disposed side by side in the longitudinal direction on a surface of the flat plate-shaped member 4Sa on a side opposite to the bending direction of the bent portion 4c. In this case, the plurality of plate-shaped blocks 4n are disposed such that there are slight gaps between adjacent plate-shaped blocks 4n. The other configurations are substantially the same as those of the insertion guide device 4 of the one embodiment described above.

In the insertion guide device 4S of the eighteenth modification example configured in this manner, when a force amount indicated by an arrow F (see FIG. 33) is applied to the distal end of the flat plate-shaped member 4Sa, the flat plate-shaped member 4Sa flexes and bends in a direction in which the bent portion 4c is bent (a direction of an arrow R1 in FIG. 33). In FIG. 33, “O” indicates that the bending is possible.

On the other hand, in a direction opposite to the bending direction of the bent portion 4c (a direction of an arrow R2 in FIG. 33), the plate-shaped blocks 4n interfere with each other, thereby preventing the flat plate-shaped member 4Sa from bending. In FIG. 33, “X” indicates that the bending is not possible.

In this way, the insertion guide device 4S of the eighteenth modification example is structured so as to allow the bending in only one direction.

In addition, as the flat plate-shaped member 4Sa, the thin plate member that is easily flexible is adopted, and thus the flat plate-shaped member can be wound as shown in FIG. 34. Therefore, when not in use, it is possible to more compactly store the insertion guide device.

As described above, according to the insertion guide device 4S of the eighteenth modification example, it is possible to obtain substantially the same effects as those of the one embodiment described above. Furthermore, according to the eighteenth modification example, the flat plate-shaped member 4Sa can be configured to bend in only one direction. In addition, the insertion guide device 4S can be easily wound, as a result, it is possible to contribute to making the insertion guide device 4S smaller when it is stored.

### Nineteenth modification example

FIG. 35 shows a nineteenth modification example of the insertion guide device according to the one embodiment of the present invention and is a main part enlarged perspective view showing a part of a distal end region of the insertion guide device.

As shown in FIG. 35, an insertion guide device 4T of the nineteenth modification example has substantially the same configuration as that of the eighteenth modification example described above, but is slightly different from that of the eighteenth modification example described above in the form of a flat plate-shaped member. In FIG. 35, a cylindrical member has the same configuration as that of the one embodiment and is therefore not shown.

As a flat plate-shaped member 4Ta in an insertion guide device 4T of the nineteenth modification example, a thin plate member formed of a band-shaped flat plate is adopted. The flat plate-shaped member 4Ta has a bent portion 4c at the distal end thereof.

In addition, the flat plate-shaped member 4Ta also has a plurality of notched grooves 4p formed across from one side surface to the other side surface in the width direction. The plurality of notched grooves 4p are formed side by side at predetermined intervals in the longitudinal direction. The plurality of notched grooves 4p are formed on a surface opposite to a bending direction of the bent portion 4c. The other configurations are substantially the same as those of the insertion guide device 4 of the one embodiment described above.

In the insertion guide device 4T of the nineteenth modification example configured in this manner, the flat plate-shaped member 4Ta flexes and bends in a direction in which the bent portion 4c is bent (a direction of an arrow R1 in FIG. 35). On the other hand, in a direction opposite to the bending direction of the bent portion 4c, adjacent notched grooves 4p interfere with each other, thereby preventing the flat plate-shaped member 4Ta from bending.

As described above, according to the insertion guide device 4T of the nineteenth modification example, it is possible to obtain substantially the same effects as those of the eighteenth modification example described above. Furthermore, according to the nineteenth modification example, the flat plate-shaped member 4Ta is formed only of a thin plate member, and thus the structure can be simplified, which contributes to miniaturization and reduction in manufacturing costs.

### Twentieth modification example

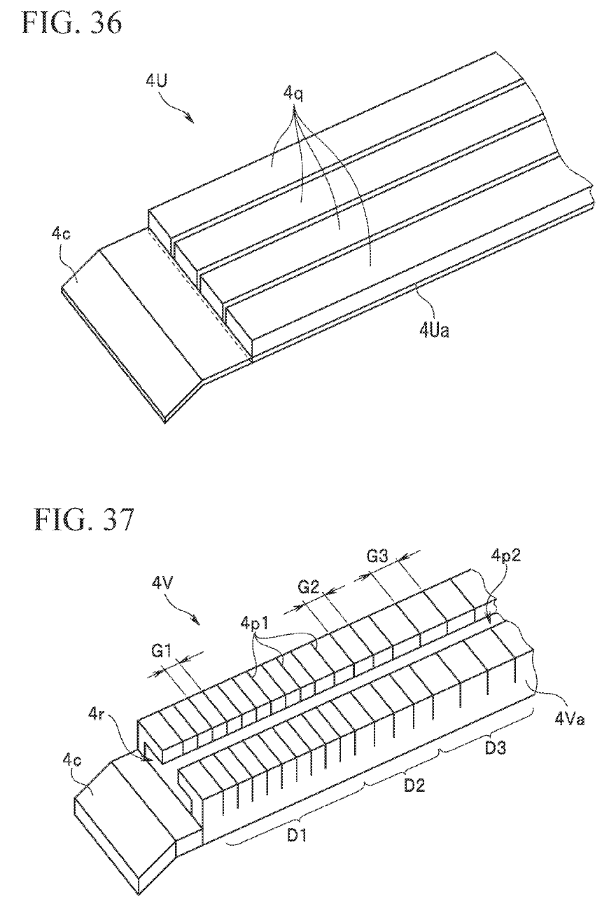

FIG. 36 shows a twentieth modification example of the insertion guide device according to the one embodiment of the present invention and is a main part enlarged perspective view showing a part of a distal end region of the insertion guide device.

As shown in FIG. 36, an insertion guide device 4U of the twentieth modification example has substantially the same configuration as that of the one embodiment or the eighteenth modification example described above, but is different from that of the one embodiment or the eighteenth modification example described above in the form of a flat plate-shaped member. In FIG. 36, a cylindrical member has the same configuration as that of the one embodiment and is therefore not shown.

The insertion guide device 4U of the twentieth modification example includes a flat plate-shaped member 4Ua, a cylindrical member (not shown), and a plurality of long plate-shaped blocks 4q.

As the flat plate-shaped member 4Ua, a thin plate member formed of a band-shaped flat plate is adopted. The flat plate-shaped member 4Ua has a plurality of bent portions 4c at the distal end thereof.

The plurality of long plate-shaped blocks 4q are disposed side by side in the width direction on a surface of the flat plate-shaped member 4Ua on a side opposite to the bending direction of the bent portion 4c. In this case, the plurality of long plate-shaped blocks 4q are disposed such that there are slight gaps between adjacent long plate-shaped blocks 4q.

In the twentieth modification example, the bent portions 4c are formed at positions corresponding to the long plate-shaped blocks 4q on both sides in the width direction among the plurality of long plate-shaped blocks 4q. The other configurations are substantially the same as those of the insertion guide device 4 or 4S of the one embodiment or the eighteenth modification example described above.

The insertion guide device 4U of the twentieth modification example formed in this manner has a structure that allows it to be wound around the longitudinal axis.

The bent portion 4c is formed to have elasticity and is bent in an open shape as shown in FIG. 36. In addition, it can be deformed and wound when it is stored.

As described above, according to the insertion guide device 4U of the twentieth modification example, it is possible to obtain substantially the same effects as those of the one embodiment described above. Furthermore, according to the twentieth modification example, the insertion guide device 4U can be stored by being wound around the longitudinal axis, as a result, it is possible to contribute to making the insertion guide device 4U easier to carry and more compact when it is stored.

### Twenty-first modification example

FIG. 37 shows a twenty-first modification example of the insertion guide device according to the one embodiment of the present invention and is a main part enlarged perspective view showing a part of a distal end region of the insertion guide device.

As shown in FIG. 37, an insertion guide device 4V of the twenty-first modification example has substantially the same configuration as that of the one embodiment or the seventh modification example described above, but is different from that of the one embodiment or the seventh modification example described above in the form of a flat plate-shaped member.

A flat plate-shaped member 4Va in the insertion guide device 4V of the twenty-first modification example has a bent portion 4c, a plurality of lateral slits 4p1, a longitudinal slit 4p2, and an internal through passage 4r. Of these, the bent portion 4c is provided at the distal end of the flat plate-shaped member 4Va.

The cross section of the flat plate-shaped member 4Va on the proximal end side with respect to the bent portion 4c has substantially a channel shape. As a result, the longitudinal slit 4p2 is formed in the longitudinal direction in a substantially central region of one flat surface of the flat plate-shaped member 4Va on a side opposite to a bending direction of the bent portion 4c. In addition, the internal through passage 4r serving as a holding member is formed in an internal region that passes through the longitudinal slit 4p2.

The plurality of lateral slits 4p1 are formed in the width direction across one flat surface of the flat plate-shaped member 4Va (the flat surface opposite to the bending direction of the bent portion 4c) and both side surfaces. The plurality of lateral slits 4p1 are formed side by side at predetermined intervals in the longitudinal direction. In this case, the intervals between the plurality of lateral slits 4p1 are set to become narrower toward the distal end.

Specifically, for example, in FIG. 37, the intervals of the lateral slits 4p1 are set to be different in a first region indicated by a reference sign D1, a second region indicated by a reference sign D2, and a third region indicated by a reference sign D3 such that the intervals becomes narrower toward the distal end.

For example, an interval G1 in the first region D1, an interval G2 in the second region D2, and an interval G3 in the third region D3 are set such that G3 > G2 > G1. By setting the intervals in this way, the flat plate-shaped member 4Va is set to be more easily flexible toward the distal end.

The internal through passage 4r is an insertion passage that passes through the flat plate-shaped member 4Va and has a relatively large space. For example, various treatment tools and the like as well as an insertion portion of an endoscope can be inserted through this internal through passage 4r. The other configurations are substantially the same as those of the insertion guide device 4 or 4G of the one embodiment or the seventh modification example described above.

As described above, according to the insertion guide device 4V of the twenty-first modification example, it is possible to obtain substantially the same effects as those of the one embodiment described above. Furthermore, according to the twenty-first modification example, the flat plate-shaped member 4Va has the internal through passage 4r as a holding member, and thus various treatment tools and the like, an endoscope, or the like can be disposed therein, as a result, it is possible to contribute to improved operability. In addition, since there is no need to provide a cylindrical member serving as a holding member on the side surface, the width direction dimension can be reduced.

### Twenty-second modification example

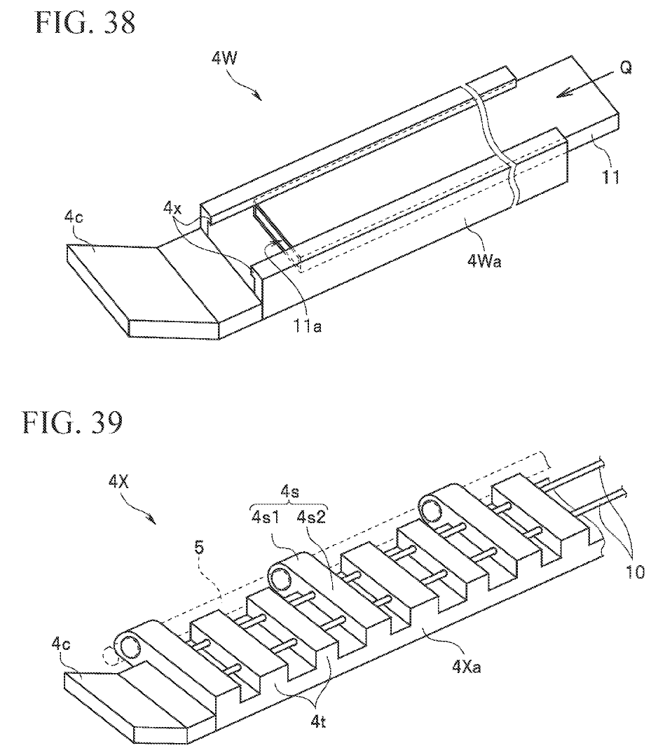

FIG. 38 shows a twenty-second modification example of the insertion guide device according to the one embodiment of the present invention and is a main part enlarged perspective view showing a part of a distal end region of the insertion guide device.

As shown in FIG. 38, an insertion guide device 4W of the twenty-second modification example has substantially the same configuration as that of the twenty-first modification example described above, but is different from that of the twenty-first modification example described above in the form of a flat plate-shaped member.

The insertion guide device 4W of the twenty-second modification example includes a flat plate-shaped member 4Wa and a holding member 11. Of these, the flat plate-shaped member 4Wa has a bent portion 4c and hook portions 4x. The bent portion 4c is provided at the distal end of the flat plate-shaped member 4Wa.

The hook portions 4x extend a predetermined length in the thickness direction from one flat surface on both side edge portions of the flat plate-shaped member 4Wa in the width direction, and then the distal ends thereof extend inward in directions opposite to each other in the width direction. As a result, each of the hook portions 4x has a hook-shaped cross section. At this time, the holding member 11 is inserted into a region surrounded by the one flat surface of the flat plate-shaped member 4Wa and the two hook portions 4x from the proximal end side of the flat plate-shaped member 4Wa in a direction of an arrow Q in FIG. 38.

The holding member 11 has a hollow rectangular cross section and has an internal space 11a that is wide in the width direction and narrow in the thickness direction. A treatment tool and the like or an insertion portion of an endoscope can be inserted into the inside of the internal space 11a. The other configurations are substantially the same as those of the insertion guide device 4 or 4V of the one embodiment or the twenty-first modification example described above.

As described above, according to the insertion guide device 4W of the twenty-second modification example, it is possible to obtain substantially the same effects as those of the one embodiment or the twenty-first modification example described above. Furthermore, according to the twenty-second modification example, an insertion passage having a relatively large space can be secured simply by inserting the holding member 11 into the region formed by the one flat surface of the flat plate-shaped member 4Wa and the hook portions 4x, making it easy to arrange various treatment tools and the like or an endoscope, or the like.

### Twenty-third modification example

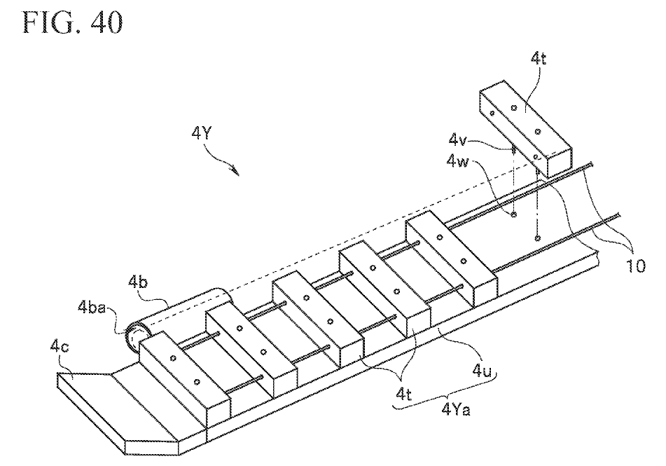

FIG. 39 shows a twenty-third modification example of the insertion guide device according to the one embodiment of the present invention and is a main part enlarged perspective view showing a part of a distal end region of the insertion guide device.

As shown in FIG. 39, an insertion guide device 4X of the twenty-third modification example has substantially the same configuration as that of the one embodiment described above, but is different from that of the one embodiment described above in the forms of a flat plate-shaped member and a holding member.

A flat plate-shaped member 4Xa in the insertion guide device 4X of the twenty-third modification example has a plurality of protrusions (4s, 4t) formed on a surface of band-shaped flat plate at predetermined intervals in the longitudinal direction. Here, the plurality of protrusions include a first protrusion 4s and a second protrusion 4t.

The first protrusion 4s has a device holding portion 4s1 that protrudes outward from one side surface of the flat plate-shaped member 4Xa in the width direction, and a wire guide 4s2 that protrudes in a direction perpendicular to the width direction on a flat surface of the flat plate-shaped member 4Xa.

The device holding portion 4s1 is a holding member that holds an insertion portion of an endoscope and the like. The device holding portion 4s1 has a through hole which passes therethrough in the longitudinal direction and allows the insertion portion of the endoscope and the like to be inserted therethrough so as to be able to be freely advanced and retreated.

The wire guide 4s2 is a holding member that guides a bending wire 10 that arbitrarily bends the insertion guide device 4X by operation. The wire guide 4s2 has through holes which pass therethrough in the longitudinal direction and allow two bending wires 10 to be inserted so as to be able to be freely advanced and retreated. The wire guide 4s2 has two through holes formed at an interval in the width direction.

The second protrusion 4t is formed by providing groove portions on the flat surface of the flat plate-shaped member 4Xa, and thus the second protrusion 4t has the same shape as the wire guide 4s2 of the first protrusion 4s. The second protrusion 4t has through holes which pass therethrough in the longitudinal direction and allow two bending wires 10 to be inserted so as to be able to be freely advanced and retreated.

The two bending wires 10 are connected to a wire operation portion (not shown) provided on the proximal end side of the insertion guide device 4X. The bending operation of the insertion guide device 4X can be performed by pulling or loosening the two bending wires 10 using the wire operation portion.

In this case, the bending operation of the flat plate-shaped member 4Xa by the bending wires 10 is usually performed mainly in a bending direction of the bent portion 4c. However, the operation is not limited to this, and for example, the flat plate-shaped member 4Xa can also be bent in the width direction. To achieve this, for example, the flat plate-shaped member 4Xa may be formed of a material with good flexibility. The other configurations are substantially the same as those of the insertion guide device 4 of the one embodiment described above.

As described above, according to the insertion guide device 4X of the twenty-third modification example, it is possible to obtain substantially the same effects as those of the one embodiment described above. Furthermore, according to the twenty-third modification example, the flat plate-shaped member 4Xa can be bent by a desired amount in a desired direction in an arbitrary and positive manner using the bending wire 10. Therefore, it is possible to further contribute to improving the ease of insertion of the endoscope insertion portion.

### Twenty-fourth modification example

FIG. 40 shows a twenty-fourth modification example of the insertion guide device according to the one embodiment of the present invention and is a main part enlarged perspective view showing a part of a distal end region of the insertion guide device.

As shown in FIG. 40, an insertion guide device 4Y of the twenty-fourth modification example has substantially the same configuration as that of the twenty-third modification example described above, but is different from that of the twenty-third modification example described above in the forms of a flat plate-shaped member and a holding member.

A flat plate-shaped member 4Ya in the insertion guide device 4Y of the twenty-fourth modification example has a bent portion 4c, a plate member 4u, and a wire guide 4t. The plate member 4u is formed in a flat band shape and includes the bent portion 4c at the distal end thereof.

The wire guide 4t is formed as a separate member from the plate member 4u, and is attachable and detachable by fitting a support pin 4v into a fitting hole 4w provided in the plate member 4u. A plurality of wire guides 4t are disposed on a flat surface of the plate member 4u at predetermined intervals in the longitudinal direction.

The wire guide 4t has through holes which pass therethrough in the longitudinal direction and are formed at a predetermined interval in the width direction. The other configurations are substantially the same as those of the insertion guide device 4X of the twenty-third modification example described above.

As described above, according to the insertion guide device 4Y of the twenty-fourth modification example, it is possible to obtain substantially the same effects as those of the twenty-third modification example described above.

### Twenty-fifth modification example

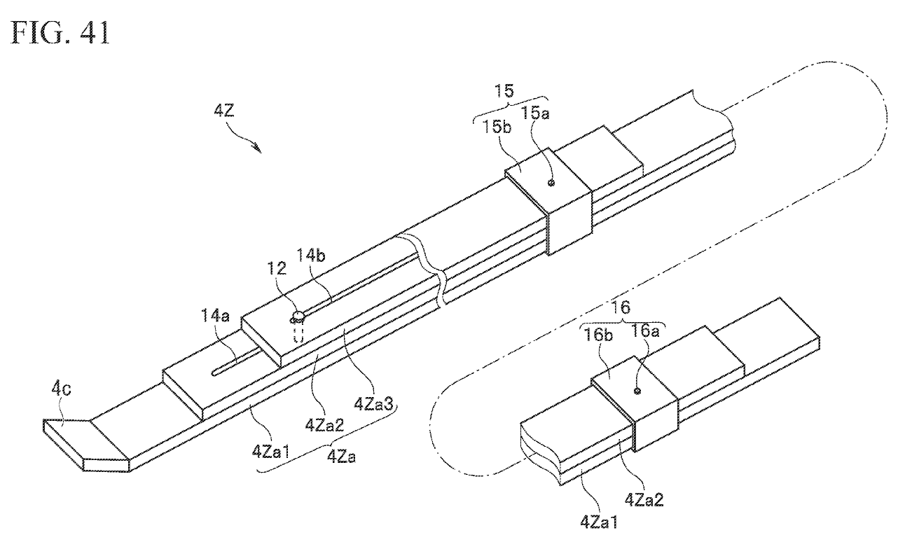

FIG. 41 shows a twenty-fifth modification example of the insertion guide device according to the one embodiment of the present invention and is a main part enlarged perspective view showing a part of a distal end region of the insertion guide device.

As shown in FIG. 41, an insertion guide device 4Z of the twenty-fifth modification example has substantially the same configuration as that of the fourth modification example described above, but is different from that of the fourth modification example described above in the form of a flat plate-shaped member. In FIG. 41, a cylindrical member has the same configuration as that of the one embodiment and is therefore not shown.

In the insertion guide device 4Z of the twenty-fifth modification example, a flat plate-shaped member 4Za has three plate members (4Za1, 4Za2, 4Za3), a bent portion 4c, and two plate member operation portions (15, 16).

The three plate members include a first plate member 4Za1, a second plate member 4Za2, and a third plate member 4Za3.

Of these, the first plate member 4Za1 has the bent portion 4c at the distal end thereof. A pin 12 is erected from a flat surface of the first plate member 4Za1 in a direction perpendicular to the longitudinal axis. The pin 12 is inserted through guide grooves (14a, 14b) of the second plate member 4Za2 and the third plate member 4Za3, which will be described below.

The second plate member 4Za2 and the third plate member 4Za3 have the guide grooves 14a and 14b extending in the longitudinal direction within a predetermined range near the distal end.

The first plate member 4Za1, the second plate member 4Za2, and the third plate member 4Za3 are stacked in the thickness direction. In this case, the three flat plate members (4Za1, 4Za2, 4Za3) are disposed such that their respective end portions are shifted by a predetermined distance in the longitudinal direction.

The two plate member operation portions (15, 16) are disposed on the proximal end side of the insertion guide device 4Z. Here, the two plate member operation portions are a third plate member operation portion 15 and a second plate member operation portion 16.

Of these, the third plate member operation portion 15 is an operation member that allows the third plate member 4Za3 to slide freely in the longitudinal direction. The third plate member operation portion 15 has a connecting pin 15a and a clamp 15b.

The connecting pin 15a is connected to the third plate member 4Za3 through the clamp 15b and allows the third plate member 4Za3 to slide in the longitudinal direction together with the clamp 15b.

The clamp 15b is a member that binds the three plate members (4Za1, 4Za2, 4Za3) at a predetermined position on the proximal end side. In this case, the clamp 15b is connected to the third plate member 4Za3 by the connecting pin 15a, but is slidable relative to the first plate member 4Za1 and the second plate member 4Za2.

The second plate member operation portion 16 is an operation member that allows the second plate member 4Za2 to slide freely in the longitudinal direction. The second plate member operation portion 16 has a connecting pin 16a and a clamp 16b.

The connecting pin 16a is connected to the second plate member 4Za2 through the clamp 16b and allows the second plate member 4Za2 to slide in the longitudinal direction together with the clamp 16b.

The clamp 16b is a member that binds the two plate members (4Za1, 4Za2) at a predetermined position on the proximal end side. In this case, the clamp 16b is connected to the second plate member 4Za2 by the connecting pin 16a, but is slidable relative to the first plate member 4Za1.

The second plate member operation portion 16 is disposed at a predetermined position closer to the proximal end than the third plate member operation portion 15. The other configurations are substantially the same as those of the one embodiment or the fourth modification example described above.

As described above, according to the insertion guide device 4Z of the twenty-fifth modification example, it is possible to obtain substantially the same effects as those of the one embodiment described above. Furthermore, according to the twenty-fifth modification example, the flexibility of the distal end can be adjusted by adjusting the positions of the three plate members in the longitudinal direction. This therefore makes it possible to contribute to further improving the ease of insertion of the endoscope insertion portion into the subject.

Incidentally, in the insertion guide device of the one embodiment and each modification example described above, there is an example of a configuration in which the holding member (the cylindrical member) to which the distal end of the endoscope insertion portion is attached is provided on the distal end side of the flat plate-shaped member and the insertion portion is fixed by the stationary portion while being inserted into the through hole of the holding member (the cylindrical member). However, the present invention is not necessarily limited to this configuration example.

For example, the holding member (the cylindrical member) may be a form which has only the through hole and in which the stationary portion is omitted.

In this case, it is considered that the through hole of the holding member (the cylindrical member) is configured such that the distal end of the insertion portion is simply fitted into the through hole to provide a loose fixation and is also configured such that the proximal end side (a hand side) of the insertion portion is securely and firmly fixed.

It is preferable that a configuration which prevents the insertion portion from being removed be further provided so as to maintain a state in which the distal end of the insertion portion is inserted in the holding member (the cylindrical member). This is because it is considered desirable that when the insertion guide device is removed after the observation inspection, the insertion portion can be removed together with the insertion guide device without detaching the insertion portion.

With this configuration, the distal end of the insertion portion can be reliably guided to a desired portion using the insertion guide device. At the same time, when the distal end of the insertion portion reaches the desired portion, the fixation of the insertion portion on the hand side can be released.

As a result, the advancing and retreating operation of the insertion portion in the longitudinal direction is ensured. Therefore, when the insertion operation of the insertion portion is performed using the insertion guide device, insertion can be performed easily and reliably, and observation and examination after insertion can be performed easily, resulting in an insertion guide device with excellent operability.

The present invention is not limited to the embodiments described above, and it goes without saying that various modifications and applications can be made within the scope of the gist of the invention. Furthermore, the above-described embodiments include inventions at various stages, and various inventions can be extracted by appropriately combining the disclosed constituent elements. For example, in a case in which the problem that the invention aims to solve can be solved and the effects of the invention can be obtained even though some of the constituent elements are deleted from all the constituent elements shown in the on embodiment describe above, the configuration from which these constituent elements are deleted can be extracted as the invention. Furthermore, constituent elements from different embodiments may be combined as appropriate. The present invention is not limited to specific embodiments thereof except as limited by the appended claims.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An insertion guide device for an endoscope which is used in an endoscope including an insertion portion extending in a longitudinal direction and having a distal end and a proximal end and guides insertion of the insertion portion into a subject, the insertion guide device comprising:
a flat plate-shaped member that extends in the longitudinal direction and has a width perpendicular to the longitudinal direction and a thickness perpendicular to the longitudinal direction and the width, the thickness being smaller than the width; and
a holding member that attaches and holds a distal end portion of the insertion portion to a width direction side surface on a distal end side of the flat plate-shaped member,
wherein the flat plate-shaped member has a bent portion that is bent in a direction of the thickness at a distal end, and
wherein the holding member is arranged on a proximal end side with respect to the bent portion.

2. The insertion guide device for an endoscope according to claim 1, wherein the holding member is cylindrical and includes a through hole through which the insertion portion is inserted and a stationary portion that fixes the diatal end portion of the insertion portion in a state in which the distal end portion is inserted into the through hole.

3. The insertion guide device for an endoscope according to claim 1, wherein the flat plate-shaped member has a plurality of plate members, and the plurality of plate members are stacked in a thickness direction.

4. The insertion guide device for an endoscope according to claim 3,
wherein, in the flat plate-shaped member, a flexible printed circuit board is disposed so as to be sandwiched between the plurality of stacked plate members,
wherein the flexible printed circuit board has an electrode protruding toward the distal end, and
wherein an electric component is connected to the electrode.

5. The insertion guide device for an endoscope according to claim 1, wherein the flat plate-shaped member is formed in a tapered shape that narrows toward the distal end.

6. The insertion guide device for an endoscope according to claim 3, wherein the plurality of stacked plate members are disposed so as to be shifted from the distal end in the longitudinal direction.

7. The insertion guide device for an endoscope according to claim 1, wherein the flat plate-shaped members extend in a width direction and are formed side by side at predetermined intervals in the longitudinal direction within a range of a predetermined region on the distal end side.

8. The insertion guide device for an endoscope according to claim 1, wherein the flat plate-shaped member is formed by connecting two plate members in the longitudinal direction, and the two plate members are formed so as to be freely foldable around a longitudinal direction.

9. An endoscope system comprising:
an endoscope including an insertion portion that extends in a longitudinal direction, has a distal end and a proximal end, and has a thin and tubular shape, an operation portion to which the proximal end of the insertion portion is connected and which is equipped with various operation members, and a cable extending from the operation portion; and
an insertion guide device for an endoscope which guides insertion of the insertion portion,
wherein the insertion guide device for an endoscope includes:
a flat plate-shaped member that extends in the longitudinal direction of the insertion portion and has a width perpendicular to the longitudinal direction and a thickness perpendicular to the longitudinal direction and the width, the thickness being smaller than the width; and
a holding member that attaches and holds a distal end portion of the insertion portion to a width direction side surface of the flat plate-shaped member,
wherein the flat plate-shaped member has a bent portion that is bent in a thickness direction at a distal end, and
wherein the holding member is arranged on a proximal end side with respect to the bent portion.
